(19) United States
(12) Patent Application Publication
(10) Pub. No.: US 2011/0290751 A1
(43) Pub. Date: Dec. 1, 2011

(54) LATTICE BOOM

(75) Inventors: Takunori YAMAGUCHI, Kobe-shi (JP); Yasuo Ichikawa, Kobe-shi (JP); Hiromitsu Hamaguchi, Kobe-shi (JP); Hitoshi Kurotsu, Akashi-shi (JP)

(73) Assignees: Kobelco Cranes Co., Ltd., Shinagawa-ku (JP); Kabushiki Kaisha Kobe Seiko Sho (Kobe Steel, Ltd.), Kobe-shi (JP)

(21) Appl. No.: 13/091,461

(22) Filed: Apr. 21, 2011

(30) Foreign Application Priority Data
Apr. 21, 2010 (JP) 2010-097965

(51) Int. Cl. B66C 23/64

(52) U.S. Cl. 212/347

(57) ABSTRACT

In a lattice boom, a first reinforcing lattice member includes a first reinforcing pipe which has a portion extending in the same direction as a first main member of a base boom and which is separated outward from a first side surface of the base boom and a first mounting part which is provided on the first reinforcing pipe and which is mounted to the first main member so as to transfer a load acting on the first main member in an axial direction of the first main member to the first reinforcing pipe, and a second reinforcing lattice member includes a second reinforcing pipe which has a portion extending in the same direction as a second main member of the base boom and which is separated outward from a second side surface of the base boom and a second mounting part which is provided on the second reinforcing pipe and which is mounted to the second main member so as to transfer a load acting on the second main member in an axial direction of the second main member to the second reinforcing pipe.

### BACKGROUND OF THE INVENTION

1. Field of the Invention

The present invention relates to a lattice boom provided on a crane.

2. Background Art

Conventionally, a lattice boom which is provided on a crane so as to be freely raised and lowered and which has a lattice structure is known. An example of a lattice boom is disclosed in Japanese Patent Application Laid-open No. H9-255283. The lattice boom comprises main pipes arranged at positions corresponding to respective vertices of a square in a cross section perpendicular to a longitudinal direction of the lattice boom, and lattice members connecting adjacent main pipes so as to form a lattice structure. This lattice boom has relatively high strength and stiffness despite being light-weight. With a crane provided with such a lattice boom, a crane operation is performed by raising and lowering the lattice boom while hanging a suspended load from a boom tip, rotating an upper slewing body to which the lattice boom is mounted, and the like.

During a crane operation performed while hanging a suspended load from the lattice boom as described above, a lateral bending load acts from the suspended load to the boom when the suspended load hung from the boom tip of the lattice boom is subjected to a crosswind, when the ground is sloped in a left-right direction of a vehicle body of the crane, during acceleration or deceleration of a rotation of the upper slewing body of the crane, and the like. When such a bending load acts on the boom, a lateral deflection occurs on the boom. Regulatory restraints are set regarding such lateral deflections of a boom, including that an amount of lateral deflection of a boom must be less than 2% of a length of the boom when a load equivalent to 2% of a suspended load is applied in a lateral direction to a boom tip. For such reasons, reduction of lateral deflection of a boom is an important issue.

While various methods for suppressing lateral deflection that occurs on a boom during a crane operation are being considered, every method is faced with various problems.

For example, with a method of suppressing lateral deflection of a boom by using members with large cross sections as components of the boom to increase lateral bending stiffness of the boom, a problem arises in that the boom's own weight increases significantly and causes a hanging capacity of a crane to decrease. Specifically, since a position of a center of gravity of a boom is distanced from a main body of a crane, an increase of the boom's own weight increases the likelihood of overturning of the crane. Therefore, the greater the boom's own weight, the smaller the maximum weight of a suspended load that can be hung by the crane while avoiding overturning in a safe manner. For such reasons, even when suppressing lateral deflection of the boom, a significant increase in the boom's own weight should be suppressed.

In addition, a method is conceivable in which lateral deflection that occurs on a boom during a crane operation is suppressed by increasing a lateral width of the boom. However, when considering transportability of the boom, increasing the width of the boom is substantially difficult.

### SUMMARY OF THE INVENTION

An object of the present invention is to provide a lattice boom that has solved the problems described above.

Another object of the present invention is to reduce lateral deflection that occurs on a lattice boom during a crane operation while avoiding a significant increase in a weight of the lattice boom and an increase in a width of the lattice boom during transportation of the lattice boom.

A lattice boom according to an aspect of the present invention is a lattice boom provided on a rotatable main body of a crane so as to be freely raised and lowered, the lattice boom comprising: a base boom including a lattice structure which extends in a specific direction and which has a first side surface facing a rotating direction of the main body of the crane and a second side surface opposite to the first side surface, with a foot of the base boom being mounted on the main body of the crane, and a tip of the base boom from which a suspended load is to be hung; a first reinforcing lattice member which is arranged so as to extend along a longitudinal direction of the base boom, and which is attachable/detachable to/from the first side surface of the base boom, and moreover which has a lattice structure; and a second reinforcing lattice member which is arranged so as to extend along the longitudinal direction of the base boom, and which is attachable/detachable to/from the second side surface of the base boom, and moreover which has a lattice structure, wherein the base boom includes a plurality of main members respectively having portions that extend in the longitudinal direction of the base boom, with the plurality of main members being separately arranged at positions corresponding to respective vertices of a square on a cross section perpendicular to the longitudinal direction of the base boom, and the main members including a first main member positioned on the first side surface and a second main member positioned on the second side surface, the first reinforcing lattice member includes a first reinforcing pipe which has a portion extending in a same direction as the first main member and which is separated outward from the first side face of the base boom and a first mounting part which is provided on the first reinforcing pipe and which is mounted to the first main member so as to transfer a load acting on the first main member in an axial direction of the first main member to the first reinforcing pipe, and the second reinforcing lattice member includes a second reinforcing pipe which has a portion extending in a same direction as the second main member and which is separated outward from the second side surface of the base boom and a second mounting part which is provided on the second reinforcing pipe and which is mounted to the second main member so as to transfer a load acting on the second main member in an axial direction of the second main member to the second reinforcing pipe.

### BRIEF DESCRIPTION OF THE DRAWINGS

FIG. 1 is a schematic side view of a crawler crane to which a lattice boom according to a first embodiment of the present invention is applied;

FIG. 2 is a partial perspective view showing a front part of a crawler crane to which a lattice boom is applied;

FIG. 3 is a diagram partially showing a range where a right reinforcing lattice member is provided among a right side surface of a lattice boom according to the first embodiment of the present invention;

FIG. 4 is a diagram partially showing, as viewed from rear, a range where a reinforcing lattice member is provided among a lattice boom according to the first embodiment of the present invention;

FIG. 5 is a perspective view partially showing a mounting structure of a right reinforcing proximal end mounting part of a right reinforcing lattice member to a right foot part of a base boom in a lattice boom according to the first embodiment of the present invention;

FIG. 6 is a rear view of the mounting structure of the right reinforcing proximal end mounting part to the right foot part shown in FIG. 5;

FIG. 7 is a rear view partially showing a mounting structure of a distal end part of a right reinforcing lattice member to a coupling part between unit booms of a base boom in a lattice boom according to the first embodiment of the present invention;

FIG. 8 is a diagram showing, from right outward, the mounting structure of the distal end part of the right reinforcing lattice member to the coupling part between unit booms shown in FIG. 7;

FIG. 9 is a diagram schematically showing a cross section perpendicular to a longitudinal direction of a lattice boom according to the first embodiment of the present invention;

FIG. 10 is a diagram partially showing a range where a right reinforcing lattice member is provided among a right side surface of a lattice boom according to a second embodiment of the present invention;

FIG. 11 is a diagram partially showing, as viewed from rear, a range where a reinforcing lattice member is provided among a lattice boom according to the second embodiment of the present invention;

FIG. 12 is a rear view partially showing a mounting structure of an intermediate part of a right reinforcing lattice member to a coupling part between a boom foot unit boom and an intermediate unit boom adjacent to the boom foot unit boom among the lattice boom shown in FIG. 11;

FIG. 13 is a diagram schematically showing a cross section perpendicular to a longitudinal direction of a lattice boom in a state where a base boom and a reinforcing lattice member have been separated from each other according to a third embodiment of the present invention;

FIG. 14 is a diagram schematically showing a cross section perpendicular to a longitudinal direction of a lattice boom according to the third embodiment of the present invention;

FIG. 15 is a perspective view partially showing a coupling structure of a mounting plate of a reinforcing lattice member and a mounted plate of a base boom of a lattice boom according to the third embodiment of the present invention;

FIG. 16 is a diagram showing a result of a simulation studying a relationship between a length of a reinforced portion within a range from a foot part to a boom tip and a hanging capacity of the boom;

FIG. 17 is a diagram schematically showing a cross section perpendicular to a longitudinal direction of a lattice boom according to a first modification of the first embodiment of the present invention;

FIG. 18 is a diagram schematically showing a cross section perpendicular to a longitudinal direction of a left reinforcing lattice member according to a second modification of the first embodiment of the present invention;

FIG. 19 is a diagram schematically showing a cross section perpendicular to a longitudinal direction of a lattice boom according to a third modification of the first embodiment of the present invention;

FIG. 20 is a diagram schematically showing a cross section perpendicular to a longitudinal direction of a left reinforcing lattice member according to a fourth modification of the first embodiment of the present invention;

FIG. 21 is a diagram schematically showing a cross section perpendicular to a longitudinal direction of a lattice boom according to a fifth modification of the first embodiment of the present invention;

FIG. 22 is a diagram schematically showing a cross section perpendicular to a longitudinal direction of a lattice boom according to a sixth modification of the first embodiment of the present invention; and

FIG. 23 is a diagram schematically showing a cross section perpendicular to a longitudinal direction of a lattice boom according to a modification of the third embodiment of the present invention.

### DESCRIPTION OF THE PREFERRED EMBODIMENTS

Hereinafter, embodiments of the present invention will be described with reference to the drawings.

### First Embodiment

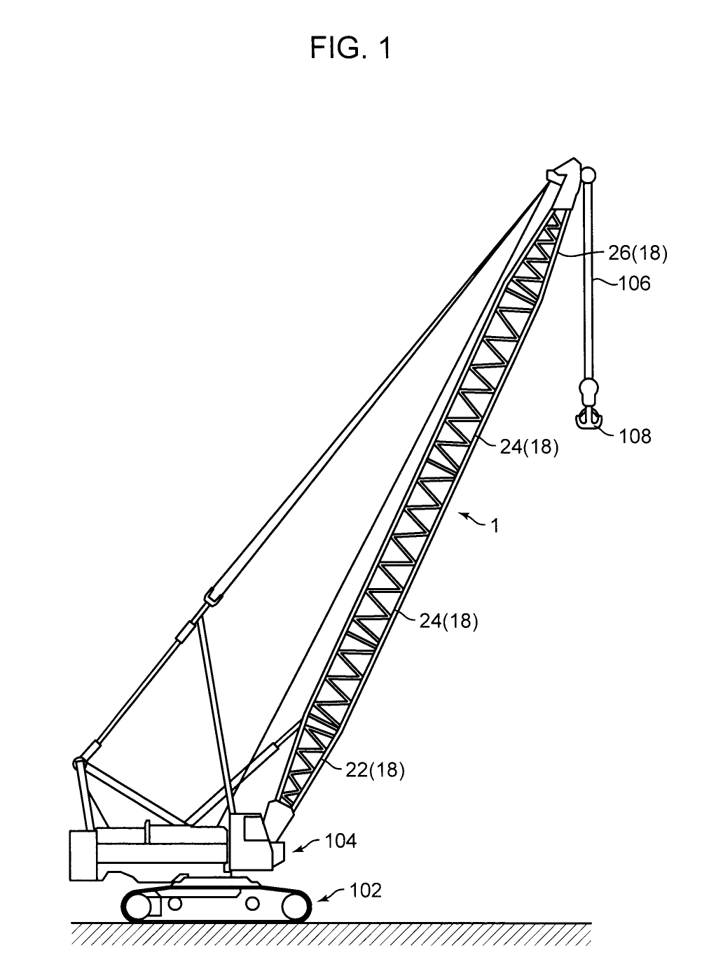

First, a configuration of a lattice boom 1 according to a first embodiment of the present invention will be described with reference to FIGS. 1 to 9.

The lattice boom 1 according to the present first embodiment is provided on, for example, a crawler crane such as that shown in FIG. 1. The crane comprises a lower propelling body 102 and an upper slewing body 104 mounted on the lower propelling body 102. The upper slewing body 104 is included in the concept of a crane main body according to the present invention. The lattice boom 1 is provided on the upper slewing body 104 so as to be freely raised and lowered. Moreover, FIG. 1 is a diagram schematically showing how the lattice boom 1 is provided on the upper slewing body 104. In FIG. 1, a detailed structure of the lattice boom 1 is shown simplified and, in particular, reinforcing lattice members 4 and 6, to be described later, have been omitted. A foot of the lattice boom 1 is mounted on the upper slewing body 104. The lattice boom 1 is configured so as to be freely raised and lowered with the foot as a fulcrum point. A hook 108 is hung via a rope 106 from a boom tip of the lattice boom 1. A suspended load is hung from the boom tip of the lattice boom 1 by the hook 108.

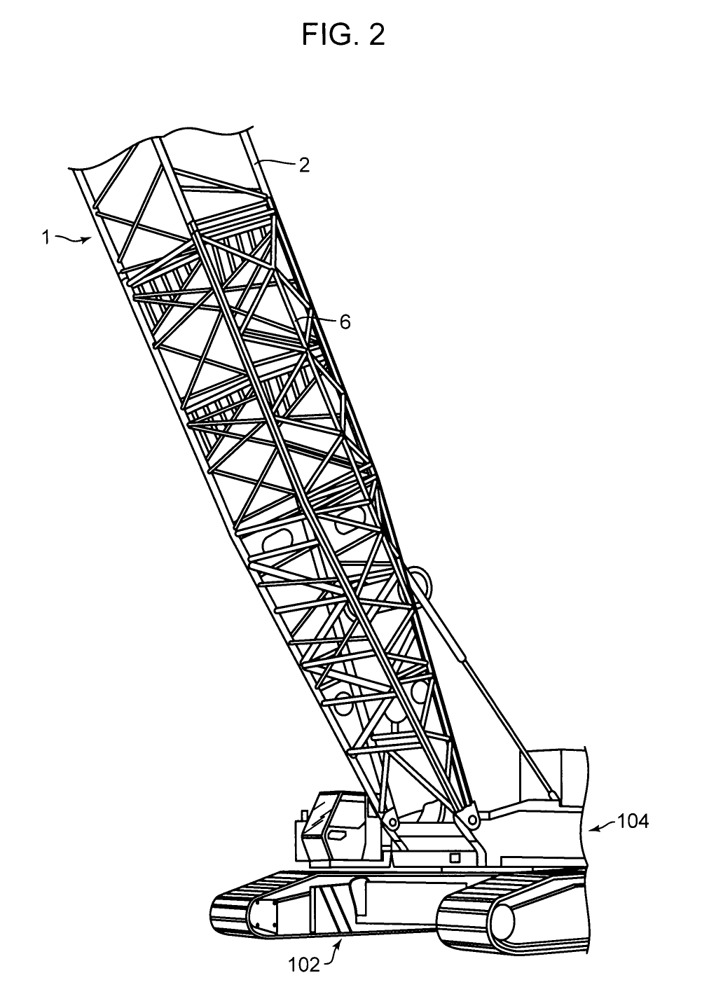

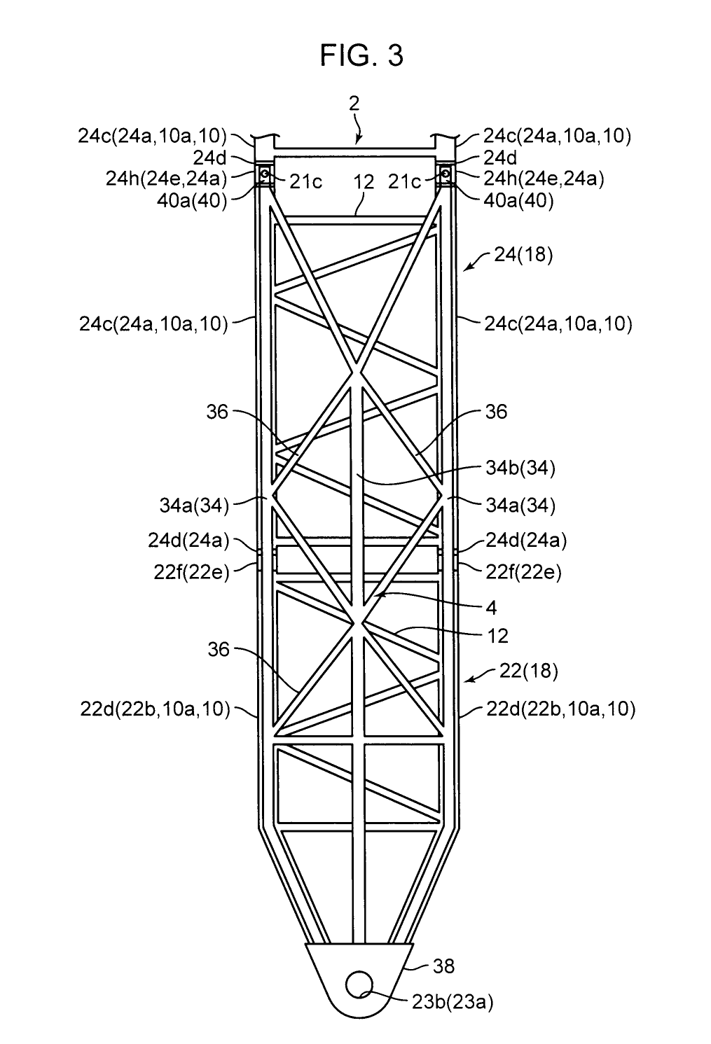

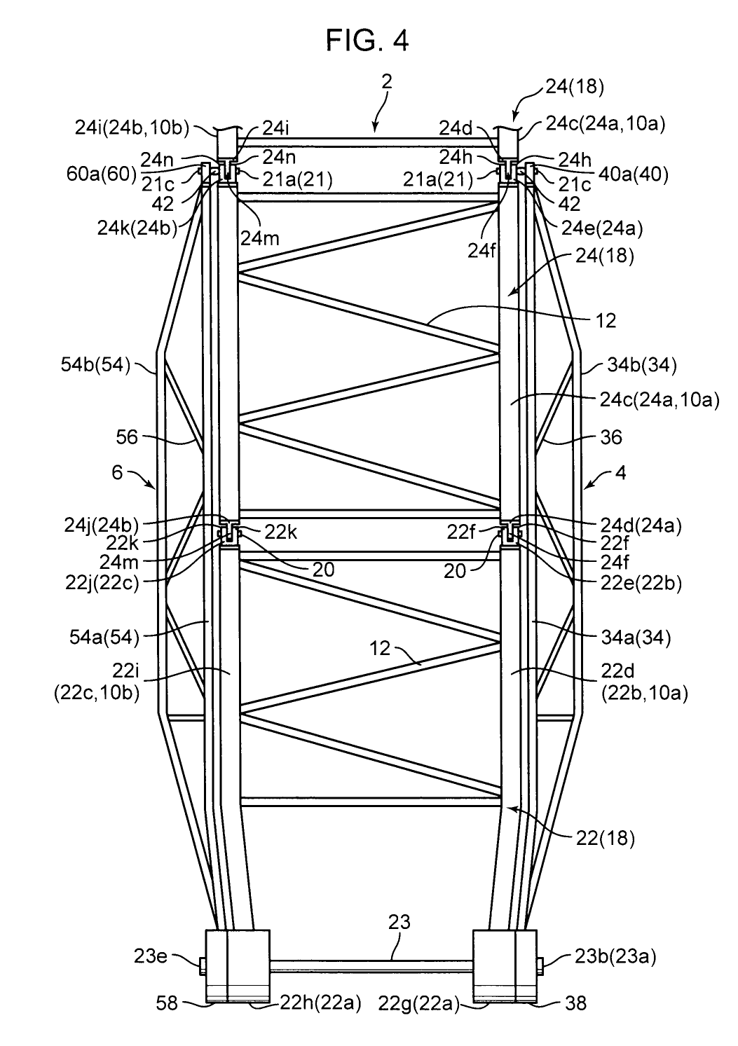

The lattice boom 1 comprises a base boom 2 (refer to FIG. 4), a right reinforcing lattice member 4 mounted to a right side surface of the base boom 2, and a left reinforcing lattice member 6 (refer to FIG. 2) mounted to a left side surface of the base boom 2. Moreover, FIG. 2 is for illustrating a positional relationship of the left reinforcing lattice member 6 with respect to the base boom 2 and a depiction of the right reinforcing lattice member 4 has been omitted. In addition, FIG. 2 does not show respective specific structures of the base boom 2 and both reinforcing lattice members 4 and 6 as well as specific mounting structures of both reinforcing lattice members 4 and 6 to the base boom 2. Such specific structures are shown in FIGS. 3 to 9.

The base boom 2 extends in a specific direction. A foot of the base boom 2 is mounted on the upper slewing body 104. The hook 108 is hung via the rope 106 from a tip of the base boom 2. In addition, the base boom 2 has a lattice structure having four surfaces facing a direction perpendicular to the specific direction (a longitudinal direction of the base boom 2). Specifically, the base boom 2 has, as shown in FIG. 1, a lattice structure having a right side surface that faces to the right of the crane, a left side surface that faces to the left of the crane, a front side surface that faces to the front of the crane, and a rear side surface that faces to the rear of the crane in a state where the base boom 2 is mounted on the upper slewing body 104 and raised so as to extend obliquely frontward and upward from the crane. Moreover, the right side surface of the base boom 2 is included in the concept of a first side surface according to the present invention, and the left side surface of the base boom 2 is included in the concept of a second side surface according to the present invention. Both left and right side surfaces of the base boom 2 face a rotating direction of the upper slewing body 104.

In addition, the base boom 2 comprises four main members 10 and a large number of sub members 12.

A major portion of the four main members 10 is constituted by round pipes. Most portions of each main member 10 excluding a proximal end part and a distal end part extend in a longitudinal direction of the base boom 2. The four main members 10 are respectively arranged at positions corresponding to respective vertices of a square on a cross section that is perpendicular to the longitudinal direction of the base boom 2. The four main members 10 comprise two right main members 10a positioned on the right side surface of the base boom 2 and two left main members 10b positioned on the left side surface of the base boom 2. Moreover, the right main member 10a is included in the concept of a first main member according to the present invention, and the left main member 10b is included in the concept of a second main member according to the present invention. The two right main members 10a are disposed on the right side surface of the base boom 2 so as to separate from each other in a front-rear direction that is perpendicular to the longitudinal direction of the base boom 2. In addition, the two left main members 10b are disposed on the left side surface of the base boom 2 so as to separate from each other in a front-rear direction that is perpendicular to the longitudinal direction of the base boom 2.

Moreover, in the present specification, the terms “right side” and “rightward” regarding the lattice boom 1 signifies the right side and rightward when facing to the front of the crane in a state where the lattice boom 1 is arranged on a front part of the crane as shown in FIG. 1, and the terms “left side” and “leftward” regarding the lattice boom 1 signifies the left side and leftward when facing to the front of the crane in the same state. In addition, the term “front side” regarding the lattice boom 1 signifies the front side of the crane in a state where the lattice boom 1 is raised at the front part of the crane as shown in FIG. 1, and the term “rear side” regarding the lattice boom 1 signifies the rear side of the crane in the same state.

The respective sub members 12 are constituted by round pipes that are smaller in diameter than those of the main members 10. Pluralities of sub members 12 are respectively arranged on the right side surface, the left side surface, the front side surface, and the rear side surface of the base boom 2. The plurality of sub members 12 arranged on the right side surface connects the two right main members 10a (refer to FIG. 3) to each other, and the plurality of sub members 12 arranged on the left side surface connects the two left main members 10b to each other. The plurality of sub members 12 arranged on the front side surface connects a right main member 10a positioned on the front side surface among the two right main members 10a with a left main member 10b positioned on the front side surface among the two left main members 10b. The plurality of sub members 12 arranged on the rear side surface connects a right main member 10a positioned on the rear side surface among the two right main members 10a with a left main member 10b positioned on the rear side surface among the two left main members 10b (refer to FIG. 4). Each sub member 12 extends in a direction that intersects with a direction in which the main member 10, to which the sub member 12 is connected, extends. The lattice structures of the respective side surfaces of the base boom 2 are formed by the sub members 12 and the main members 10.

In addition, the base boom 2 comprises a plurality of unit booms 18 which is arranged side by side in the longitudinal direction of the base boom 2 and in which adjacent unit booms 18 are coupled to each other, and pluralities of coupling pins 20 and 21 that couple adjacent unit booms 18 to each other. In other words, the base boom 2 is divided into the plurality of unit booms 18 in the longitudinal direction of the base boom 2, and adjacent unit booms 18 are coupled to each other by the coupling pin 20 or 21 to constitute the base boom 2.

The plurality of unit booms 18 comprises one boom foot unit boom 22, a plurality of intermediate unit booms 24, and one boom tip unit boom 26 (refer to FIG. 1). The boom foot unit boom 22 is positioned at the foot of the base boom 2, the boom tip unit boom 26 is positioned at the tip of the base boom 2, and the plurality of intermediate unit booms 24 is positioned between the boom foot unit boom 22 and the boom tip unit boom 26.

The boom foot unit boom 22 constitutes the foot of the base boom 2. The boom foot unit boom 22 comprises a boom foot 22a, two right foot unit main members 22b, and two left foot unit main members 22c.

The boom foot 22a is arranged at a foot position of the base boom 2, in other words, a proximal end position of the boom foot unit boom 22. The boom foot 22a is mounted on the upper slewing body 104. The boom foot 22a comprises a right foot part 22g positioned on the right side surface of the base boom 2 and a left foot part 22h positioned on the left side surface of the base boom 2. The right foot part 22g is included in the concept of a first foot part according to the present invention, and the left foot part 22h is included in the concept of a second foot part according to the present invention.

The right foot part 22g is provided on proximal end parts of the two right foot unit main members 22b, in other words, proximal end parts of the two right main members 10a, and is mounted to the upper slewing body 104. The left foot part 22h is provided on proximal end parts of the two left foot unit main members 22c, in other words, proximal end parts of the two left main members 10b, and is mounted to the upper slewing body 104. The right foot part 22g is constituted by a plate-like member arranged along the right side surface of the base boom 2, and the left foot part 22h is constituted by a plate-like member arranged along the left side surface of the base boom 2. The right foot part 22g is provided with a foot hole 22l (refer to FIG. 6) that penetrates the right foot part 22g in a direction intersecting the direction in which the right main members 10a extend and, more specifically, in a left-right direction (a thickness direction of the right foot part 22g). In addition, the left foot part 22h is provided at a position corresponding to the foot hole 22l of the right foot part 22g with a similar foot hole (not shown) that penetrates the left foot part 22h in a direction intersecting the direction in which the left main members 10b extend and, more specifically, in a left-right direction (a thickness direction of the left foot part 22h). The boom foot unit boom 22 is mounted to the upper slewing body 104 by having a foot pin 23 fitted and inserted into the foot holes of both foot parts 22g and 22h and, at the same time, having the foot pin 23 fitted and inserted into a mounting hole of a boom mounting part (not shown) of the upper slewing body 104 between both foot parts 22g and 22h. The base boom 2 (lattice boom 1) is raised and lowered with the foot pin 23 as a support shaft.

Each right foot unit main member 22b constitutes a portion in a vicinity of the proximal end part of a corresponding right main member 10a among the two right main members 10a. Each right foot unit main member 22b comprises a right foot unit pipe 22d and a right distal end connecting part 22e.

The right foot unit pipe 22d is constituted by a round pipe. The right foot unit pipe 22d is included in the concept of a first unit pipe according to the present invention. A proximal end part of the right foot unit pipe 22d is coupled to the right foot part 22g. Portions having a predetermined length from a proximal end part toward a distal end-side among the right foot unit pipes 22d of the two right foot unit main members 22b extend obliquely so as to gradually separate from each other toward the distal end-side on the right side surface of the base boom 2, and portions further toward the distal end-side than the portions with the predetermined length extend parallel to each other along the longitudinal direction of the base boom 2.

The right distal end connecting part 22e is provided on a distal end part of the right foot unit pipe 22d. The right distal end connecting part 22e comprises a pair of flat plate-like receiving plate parts 22f separated from each other in a width direction (left-right direction) of the base boom 2 and arranged parallel to each other. The respective receiving plate parts 22f are provided with through holes that penetrate the receiving plate parts 22f at the same position in a thickness direction.

Each left foot unit main member 22c constitutes a portion in a vicinity of the proximal end part of a corresponding left main member 10b among the two left main members 10b. The left foot unit main member 22c has a structure that is a mirror-reversed structure of the right foot unit main member 22b. Specifically, each left foot unit main member 22c comprises a left foot unit pipe 22i having a structure that is mirror-reversed structure of the right foot unit pipe 22d and a left distal end connecting part 22j having a structure that is mirror-reversed structure of the right distal end connecting part 22e. The left foot unit pipe 22i is constituted by a round pipe and a proximal end part of the left foot unit pipe 22i is coupled to the left foot part 22h. The left foot unit pipe 22i is included in the concept of a second unit pipe according to the present invention. The left distal end connecting part 22j comprises a pair of receiving plate parts 22k similar to the pair of receiving plate parts 22f of the right distal end connecting part 22e.

In addition, on the four side surfaces of the boom foot unit boom 22, pluralities of sub members 12 are respectively disposed between the two foot unit pipes 22d or the two foot unit pipes 22i positioned on the respective side surfaces, and the two foot unit pipes 22d or the two foot unit pipes 22i positioned on the respective side surfaces are coupled to each other by the sub members 12. In other words, the boom foot unit boom 22 also includes a predetermined number of sub members 12.

The plurality of intermediate unit booms 24 is connected to the distal end part of the boom foot unit boom 22 and linearly connected in sequence toward the tip of the base boom 2. Each of the intermediate unit booms 24 comprises two right intermediate unit main members 24a and two left intermediate unit main members 24b.

Each right intermediate unit main member 24a of a predetermined intermediate unit boom 24 constitutes an intermediate region in a longitudinal direction of a corresponding right main member 10a among the two right main members 10a. Each right intermediate unit main member 24a comprises a right intermediate unit pipe 24c, a right proximal end connecting part 24d, and a right distal end connecting part 24e.

The right intermediate unit pipe 24c is constituted by a round pipe. The right intermediate unit pipe 24c is included in the concept of the first unit pipe according to the present invention. The right intermediate unit pipe 24c linearly extends along the longitudinal direction of the base boom 2. The respective right intermediate unit pipes 24c of the plurality of right intermediate unit main members 24a constituting each right main member 10a are arranged side by side in the longitudinal direction of the right main member 10a. In addition, the right intermediate unit pipes 24c of the two right intermediate unit main members 24a extend parallel to each other.

The right proximal end connecting part 24d is provided on a proximal end part of the right intermediate unit pipe 24c. The right proximal end connecting part 24d of each right intermediate unit main member 24a among adjacent intermediate unit booms 24 on the tip-side of the lattice boom 1 with respect to the boom foot unit boom 22 is connected to a corresponding right distal end connecting part 22e among the two right distal end connecting parts 22e of the boom foot unit boom 22.

Specifically, the right proximal end connecting part 24d of the intermediate unit boom 24 adjacent on the tip-side of the lattice boom 1 to the right foot unit pipe 22d of the boom foot unit boom 22 comprises a flat plate-like inserted part 24f that is inserted between the pair of receiving plate parts 22f of the right distal end connecting part 22e of the boom foot unit boom 22. The inserted part 24f is provided with a through hole arranged so as to communicate with the through hole provided on the receiving plate parts 22f. In addition, by having the coupling pin 20 fitted and inserted through the through holes of both receiving plate parts 22f and the through hole of the inserted part 24f in a state where the inserted part 24f is inserted between the pair of receiving plate parts 22f, the right distal end connecting part 22e of the boom foot unit boom 22 and the right proximal end connecting part 24d of the intermediate unit boom 24 positioned adjacent to the boom foot unit boom 22 are coupled to each other.

The right distal end connecting part 24e of the right intermediate unit main member 24a is provided on a distal end part of the right intermediate unit pipe 24c. The right distal end connecting part 24e of the right intermediate unit main member 24a is configured similar to the right distal end connecting part 22e of the boom foot unit boom 22, and comprises a pair of receiving plate parts 24h similar to the pair of receiving plate parts 22f of the right distal end connecting part 22e.

Each of the left intermediate unit main members 24b constitutes an intermediate region in a longitudinal direction of a corresponding left main member 10b among the two left main members 10b. The left intermediate unit main member 24b has a structure that is a mirror-reversed structure of the right intermediate unit main member 24a. Specifically, each left intermediate unit main member 24b comprises a left intermediate unit pipe 24i, a left proximal end connecting part 24j, and a left distal end connecting part 24k having structures that are mirror-reversed structures of the right intermediate unit pipe 24c, the right proximal end connecting part 24d, and the right distal end connecting part 24e. The left intermediate unit pipe 24i is included in the concept of the second unit pipe according to the present invention.

On the four side surfaces of the intermediate unit boom 24, pluralities of sub members 12 are respectively disposed between the two intermediate unit pipes 24c or the two intermediate unit pipes 24i positioned on the respective side surfaces, and the two intermediate unit pipes 24c or the two intermediate unit pipes 24i positioned on the respective side surfaces are coupled to each other by the sub members 12. In other words, the intermediate unit boom 24 also includes a predetermined number of sub members 12.

The left proximal end connecting part 24j comprises an inserted part 24m similar to the inserted part 24f of the right proximal end connecting part 24d. The inserted part 24m is inserted between the pair of receiving plate parts 22k of the left distal end connecting part 22j of the boom foot unit boom 22 and is coupled to the receiving plate parts 22k in this state by the coupling pin 20. The left distal end connecting part 24k comprises a pair of receiving plate parts 24n similar to the pair of receiving plate parts 24h of the right distal end connecting part 24e.

Intermediate unit booms 24 other than the intermediate unit boom 24 connected to the boom foot unit boom 22 have a similar configuration to that of the intermediate unit boom 24 described above. Inserted between the pair of receiving plate parts 24h of the right distal end connecting part 24e among an intermediate unit boom 24 that is adjacent to the boom foot unit boom 22 is the inserted part 24f of the right proximal end connecting part 24d of a different intermediate unit boom 24 that is adjacent to the distal end-side of the intermediate unit boom 24, and the pair of receiving plate parts 24h and the inserted part 24f are coupled by the coupling pin 21.

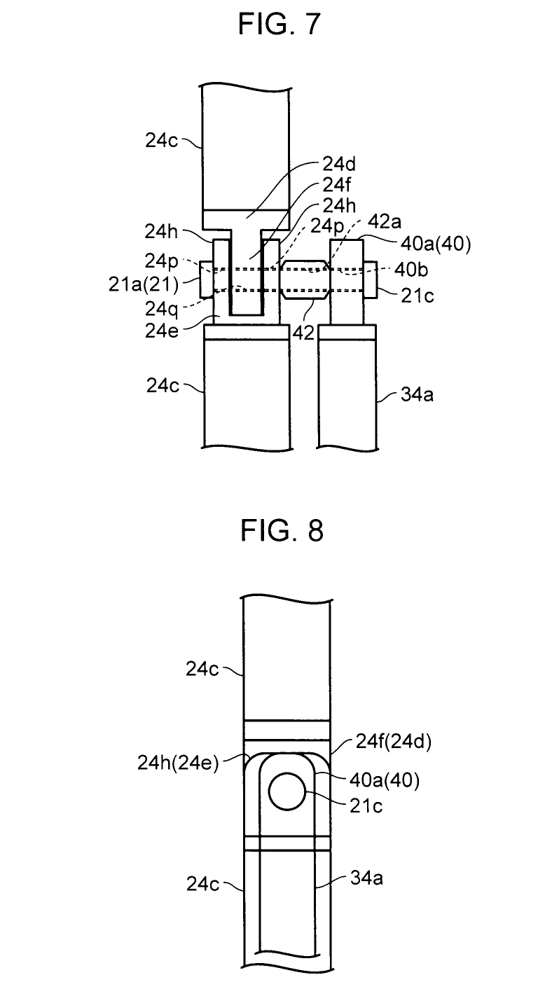

Specifically, a through hole 24p (refer to FIG. 7) similar to the through hole provided on the receiving plate parts 22f of the right distal end connecting part 22e of the boom foot unit boom 22 is provided on the receiving plate parts 24h of the right distal end connecting part 24e of the intermediate unit boom 24. In addition, the inserted part 24f of a different intermediate unit boom 24 adjacent on the distal end-side of the intermediate unit boom 24 is provided with a through hole 24q arranged so as to communicate with the through hole 24p of the receiving plate parts 24h in a state where the inserted part 24f is inserted between the pair of receiving plate parts 24h. The through hole 24p provided on the receiving plate parts 24h and the through hole 24q provided on the inserted part 24f are included in the concept of a first mounted through hole according to the present invention. In addition, by having the coupling pin 21 fitted and inserted into the through hole 24p of the receiving plate parts 24h and the through hole 24q of the inserted part 24f, the receiving plate parts 24h and the inserted part 24f are coupled to each other.

Furthermore, the pair of receiving plate parts 24n of the left distal end connecting part 24k among an intermediate unit boom 24 that is adjacent to the boom foot unit boom 22 and the inserted part 24m of the left proximal end connecting part 24j of a different intermediate unit boom 24 that is adjacent to the distal end-side of the intermediate unit boom 24 are coupled to each other by the coupling pin 21 in a coupling structure similar to that of the pair of receiving plate parts 24h of the right distal end connecting part 24e and the inserted part 24f.

Moreover, coupling positions of the right distal end connecting part 24e and the left distal end connecting part 24k of the intermediate unit boom 24 adjacent to the boom foot unit boom 22 with the right proximal end connecting part 24d and the left proximal end connecting part 24j of a different intermediate unit boom 24 adjacent to the distal end-side of the intermediate unit boom 24 are closer toward the foot than the intermediate part in the longitudinal direction of the base boom 2.

Intermediate unit booms 24 other than those described above are connected in sequence to the tip-side of the base boom 2 by similar coupling structures as described above.

The boom tip unit boom 26 is connected to a distal end part of an intermediate unit boom 24 arranged closest to the tip of the base boom 2 among the plurality of intermediate unit booms 24. The hook 108 is hung via the rope 106 from a distal end part of the boom tip unit boom 26. A coupling structure of the intermediate unit boom 24 positioned closest to the tip of the base boom 2 among the plurality of intermediate unit booms 24 to the boom tip unit boom 26 is similar to the coupling structure between adjacent intermediate unit booms 24.

The right reinforcing lattice member 4 and the left reinforcing lattice member 6 are mounted to the right and left of the base boom 2 to improve a bending strength and a bending stiffness in a left-right direction (lateral direction) of the base boom 2 and, consequently, reduces a deflection of the base boom 2 in the left-right direction (lateral direction). When a rightward bending load acts on the base boom 2, the right reinforcing lattice member 4 counteracts the load so as to provide bracing to suppress rightward deflection of the base boom 2. When a leftward bending load acts on the base boom 2, the left reinforcing lattice member 6 counteracts the load so as to provide bracing to suppress leftward deflection of the base boom 2. The right reinforcing lattice member 4 is included in the concept of a first reinforcing lattice member according to the present invention, and the left reinforcing lattice member 6 is included in the concept of a second reinforcing lattice member according to the present invention.

Specifically, the right reinforcing lattice member 4 is mounted on the right side surface of the base boom 2. The right reinforcing lattice member 4 is arranged so as to extend along the longitudinal direction of the base boom 2. In addition, the right reinforcing lattice member 4 is configured so as to be attachable/detachable to/from the right side surface of the boom foot unit boom 22 and the right side surface of the intermediate unit boom 24 adjacent to the distal end-side of the boom foot unit boom 22 among the base boom 2. Furthermore, the right reinforcing lattice member 4 has a lattice structure. The right reinforcing lattice member 4 comprises three right reinforcing main pipes 34, a plurality of right reinforcing sub pipes 36, one right reinforcing proximal end mounting part 38, and two right reinforcing distal end mounting parts 40.

The three right reinforcing main pipes 34 are separated right outward from the two right main members 10a of the base boom 2. Each right reinforcing main pipe 34 is constituted by a hollow round pipe that has a smaller diameter than the right main members 10a. Moreover, the right reinforcing main pipe 34 is included in the concept of a first reinforcing pipe according to the present invention. In addition, the three right reinforcing main pipes 34 comprise two right adjacent reinforcing main pipes 34a that are included in the concept of a first adjacent reinforcing main pipe according to the present invention and one right separated reinforcing main pipe 34b that is included in the concept of a first separated reinforcing main pipe according to the present invention.

One of the two right adjacent reinforcing main pipes 34a is arranged at a position in a right outward vicinity of one of the two right foot unit main members 22b of the boom foot unit boom 22 and one of the two right intermediate unit main members 24a of the intermediate unit boom 24 connected to the one right foot unit main member 22b, and is arranged so as to extend along the one right foot unit main member 22b and the one right intermediate unit main member 24a. The other of the two right adjacent reinforcing main pipes 34a is arranged at a position in a right outward vicinity of the other of the two right foot unit main members 22b of the boom foot unit boom 22 and the other of the two right intermediate unit main members 24a of the intermediate unit boom 24 connected to the other right foot unit main member 22b, and is arranged so as to extend along the other right foot unit main member 22b and the other right intermediate unit main member 24a.

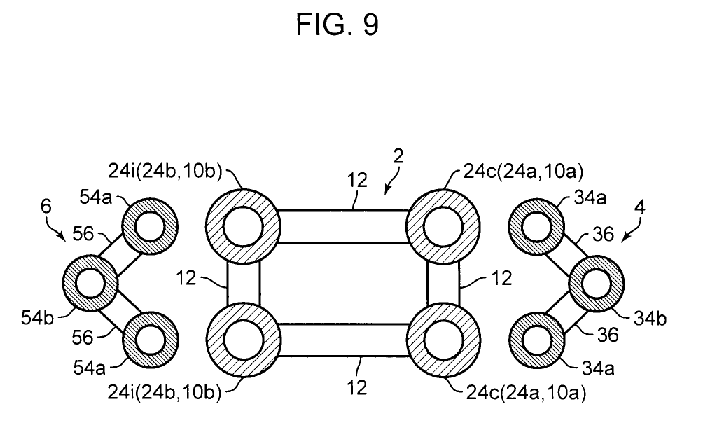

The right separated reinforcing main pipe 34b is arranged between the two right adjacent reinforcing main pipes 34a when viewing the lattice boom 1 from the right. The right separated reinforcing main pipe 34b has a portion which is disposed so as to separate from the right adjacent reinforcing main pipe 34a toward an opposite side of the side of the right side surface of the base boom 2 and which extends in the longitudinal direction of the base boom 2. Specifically, a proximal end-side portion that covers a predetermined length from the proximal end toward a distal end-side of the right separated reinforcing main pipe 34b extends obliquely so as to gradually recede outward from the right side surface of the base boom 2 the closer to the distal end side from the proximal end side. In addition, an intermediate portion extending toward the tip-side of the base boom 2 from the distal end of a proximal end-side portion of the right separated reinforcing main pipe 34b extends approximately parallel to the right side surface of the base boom 2. The intermediate portion extends in the same direction as a portion linearly extending in the longitudinal direction of the base boom 2 among the right main members 10a. Furthermore, the proximal end-side portion and the intermediate portion are arranged at a center between the two right adjacent reinforcing main pipes 34a when viewing the lattice boom 1 from the right. As shown in FIG. 9, the intermediate portion of the right separated reinforcing main pipe 34b is arranged so as to separate widely to right outward than the right adjacent reinforcing main pipes 34a with respect to the right side surface of the base boom 2. Moreover, a distal end-side portion connecting to a distal end-side of the intermediate portion among the right separated reinforcing main pipe 34b is bifurcated. One of the bifurcated distal end-side portions extends obliquely so as to gradually approach one of the two right adjacent reinforcing main pipes 34a the further toward a distal end from a proximal end of the one bifurcated distal end-side portion, and a distal end part of the one of the bifurcated distal end-side portions is coupled to the one of the right adjacent reinforcing main pipes 34a. In addition, the other of the bifurcated distal end-side portions extends obliquely so as to gradually approach the other of the two right adjacent reinforcing main pipes 34a the further toward a distal end from a proximal end of the other bifurcated distal end-side portion, and a distal end part of the other bifurcated distal end-side portion is coupled to the other of the right adjacent reinforcing main pipes 34a.

The plurality of right reinforcing sub pipes 36 is included in the concept of a first reinforcing sub pipe according to the present invention. The plurality of right reinforcing sub pipes 36 connects the right separated reinforcing main pipe 34b and the two right adjacent reinforcing main pipes 34a to each other. Accordingly, lattice structures are respectively formed between the right separated reinforcing main pipe 34b and the respective right adjacent reinforcing main pipes 34a. The right reinforcing sub pipes 36 respectively connected from the right separated reinforcing main pipe 34b to the two right adjacent reinforcing main pipes 34a are arranged symmetrically.

The right reinforcing proximal end mounting part 38 is provided on a proximal end part of the right adjacent reinforcing main pipe 34a and a proximal end part of the right separated reinforcing main pipe 34b. The right reinforcing proximal end mounting part 38 is arranged on the proximal end part of the right reinforcing lattice member 4. The right reinforcing proximal end mounting part 38 is included in the concept of a first proximal end mounting part according to the present invention. The right reinforcing proximal end mounting part 38 is mounted to the right foot part 22g by the foot pin 23.

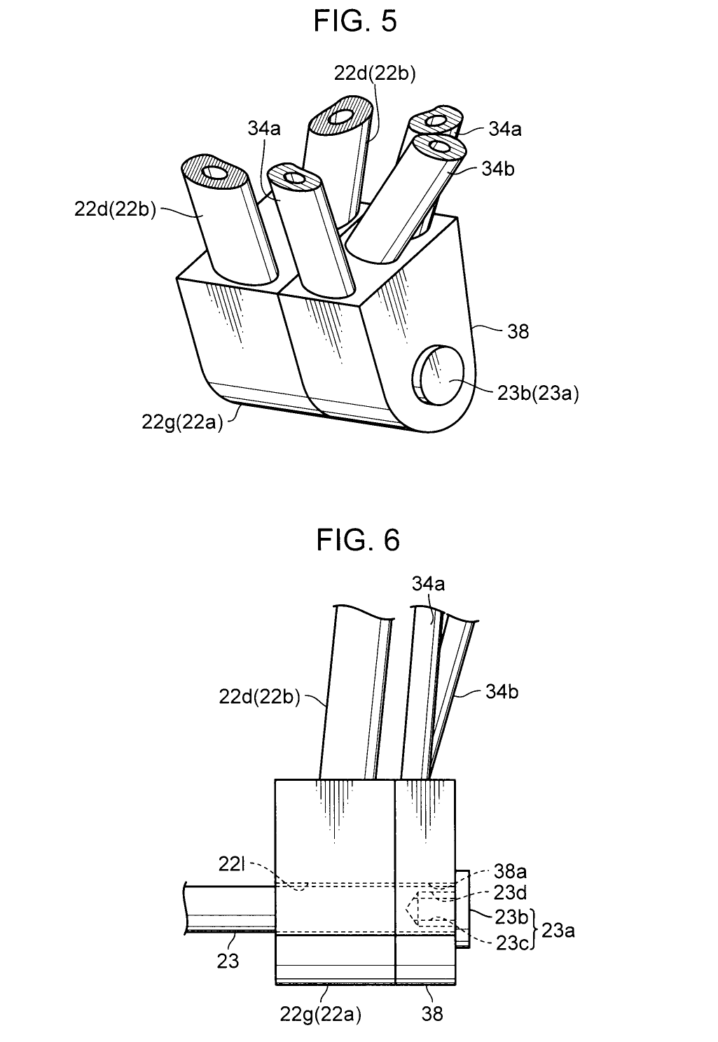

Specifically, as shown in FIGS. 3 and 5, the right reinforcing proximal end mounting part 38 is constituted by a plate-like member having a shape similar to the right foot part 22g as viewed from right outward. The right reinforcing proximal end mounting part 38 is arranged so as to come into contact with a right side surface of the right foot part 22g. The right reinforcing proximal end mounting part 38 is provided with a through hole 38a (refer to FIG. 6) that communicates with the foot hole 22l of the right foot part 22g in this state. A right end part of the foot pin 23 protruding rightward through the foot hole 22l is fitted and inserted into the through hole 38a. By having a detachment preventing member 23a coupled to the right end part of the foot pin 23 from right outward of the right reinforcing proximal end mounting part 38, the right reinforcing proximal end mounting part 38 is prevented from detaching from the foot pin 23 and is fixed to the right foot part 22g. The detachment preventing member 23a comprises a head part 23b with a larger diameter than the through hole 38a of the right reinforcing proximal end mounting part 38, and a screw part 23c that extends leftward from the head part 23b. A screw hole 23d is formed on the right end part of the foot pin 23. By having the screw part 23c of the detachment preventing member 23a screwed into the screw hole 23d, the detachment preventing member 23a is coupled to the right end part of the foot pin 23. The right reinforcing proximal end mounting part 38 is pressed by the head part 23b of the detachment preventing member 23a and thereby fixed to the right foot part 22g.

Each of the two right reinforcing distal end mounting parts 40 are provided on a distal end part of a corresponding right adjacent reinforcing main pipe 34a among the two right adjacent reinforcing main pipes 34a. The two right reinforcing distal end mounting parts 40 are arranged on the distal end part of the right reinforcing lattice member 4. The right reinforcing distal end mounting parts 40 are included in the concept of a first mounting part according to the present invention. When the right reinforcing lattice member 4 is mounted to the base boom 2, each right reinforcing distal end mounting part 40 is mounted by the coupling pin 21 to the right distal end connecting part 24e provided on the distal end part of the right intermediate unit pipe 24c adjacent on the tip side of the lattice boom 1 to the corresponding right foot unit pipe 22d, and also mounted by the coupling pin 21 to the right proximal end connecting part 24d provided on the proximal end part of another right intermediate unit pipe 24c adjacent on the tip side of the lattice boom 1 to the right intermediate unit pipe 24c. Moreover, the right distal end connecting part 24e provided on the distal end part of the right intermediate unit pipe 24c adjacent on the tip side of the lattice boom 1 to the right foot unit pipe 22d is included in the concept of a first distal end connecting part according to the present invention. In addition, the right proximal end connecting part 24d provided on the proximal end part of another right intermediate unit pipe 24c adjacent further on the tip side of the lattice boom 1 to the right intermediate unit pipe 24c is included in the concept of a first proximal end connecting part according to the present invention. In addition, the coupling pin 21 which connects the right distal end connecting part 24e and the right proximal end connecting part 24d to each other and which mounts the right reinforcing distal end mounting part 40 to both connecting parts 24e and 24d is included in the concept of a first coupling member according to the present invention. The right reinforcing distal end mounting part 40 is mounted to the right main member 10a such that when a bending load in a left-right direction acts on the lattice boom 1 and a compressive load or a tensile load in an axial direction acts on the right main member 10a, the load is transferred to the right adjacent reinforcing main pipe 34a and the right separated reinforcing main pipe 34b.

Specifically, as shown in FIGS. 7 and 8, the right reinforcing distal end mounting part 40 comprises a flat plate-like mounting plate part 40a which is arranged so as to separate right outward from the right-side receiving plate part 24h of the right distal end connecting part 24e and which is arranged approximately parallel to the receiving plate part 24h. The mounting plate part 40a is provided with a right reinforcing mounting through hole 40b at a position corresponding to the through hole 24p of the receiving plate part 24h. The right reinforcing mounting through hole 40b is included in the concept of a first mounting through hole according to the present invention. The right reinforcing mounting through hole 40b penetrates the mounting plate part 40a in the same direction (left-right direction) as the through hole 24p of the receiving plate part 24h and the through hole 24a of the inserted part 24f. A sleeve 42 that functions as a spacer is sandwiched between the mounting plate part 40a and the right-side receiving plate part 24h of the right distal end connecting part 24e. The sleeve 42 is provided with a through hole 42a that penetrates the sleeve 42 in a left-right direction. The coupling pin 21 fitted and inserted into the through hole 24p of the pair of receiving plate parts 24h of the right distal end connecting part 24e and the through hole 24a of the inserted part 24f protrudes rightward from the right-side receiving plate part 24h. The portion of the coupling pin 21 that protrudes rightward from the right-side receiving plate part 24h is fitted and inserted into the through hole 42a of the sleeve 42 and the right reinforcing mounting through hole 40b of the mounting plate part 40a. A screw hole (not shown) similar to the screw hole 23d of the foot pin 23 is formed on a right end part of the coupling pin 21. In addition, the coupling pin 21 is provided on a left end thereof with a pinhead 21a whose diameter is larger than that of the through hole 24p of the receiving plate part 24h. A screwed cap 21c is screwed into and tightened from the right of the mounting plate part 40a into the screw hole provided on a right end part of the coupling pin 21. A head part of the cap 21c has a diameter that is greater than the right reinforcing mounting through hole 40b of the mounting plate part 40a. By sandwiching the pair of receiving plate parts 24h, the inserted part 24f, the sleeve 42, and the mounting plate part 40a between the head part of the cap 21c and the pinhead 21a of the coupling pin 21, the pair of receiving plate parts 24h, the inserted part 24f, the sleeve 42, and the mounting plate part 40a are fixed to each other. Moreover, by loosening the fastening of the screw part of the cap 21c to the screw hole of the coupling pin 21 and removing the cap 21c from the coupling pin 21, the right reinforcing distal end mounting part 40 can be removed from the coupling pin 21 and the right reinforcing distal end mounting part 40 can be separated from the right proximal end connecting part 24d and the right distal end connecting part 24e.

The left reinforcing lattice member 6 (refer to FIG. 4) is mounted to the left side surface of the base boom 2 that is a side surface opposite to the right side surface of the base boom 2 to which the right reinforcing lattice member 4 is mounted. The left reinforcing lattice member 6 is arranged so as to extend along the longitudinal direction of the base boom 2, and is configured so as to be attachable/detachable to/from left side surfaces of the boom foot unit boom 22 and an intermediate unit boom 24 adjacent on a distal end side of the boom foot unit boom 22 among the base boom 2. In addition, the left reinforcing lattice member 6 has a structure that is a mirror-reversed structure of the right reinforcing lattice member 4. Specifically, the left reinforcing lattice member 6 comprises three left reinforcing main pipes 54, a left reinforcing sub pipe 56, a left reinforcing proximal end mounting part 58, and two left reinforcing distal end mounting parts 60 which respectively correspond to the three right reinforcing main pipes 34, the right reinforcing sub pipe 36, the right reinforcing proximal end mounting part 38, and the two right reinforcing distal end mounting parts 40 of the right reinforcing lattice member 4. The left reinforcing main pipe 54 is included in the concept of a second reinforcing pipe according to the present invention. The left reinforcing sub pipe 56 is included in the concept of a second reinforcing sub pipe according to the present invention. In addition, the left reinforcing main pipe 54 comprises a left adjacent reinforcing main pipe 54a and a left separated reinforcing main pipe 54b respectively corresponding to the right adjacent reinforcing main pipe 34a and the right separated reinforcing main pipe 34b. The left adjacent reinforcing main pipe 54a is included in the concept of a second adjacent reinforcing main pipe according to the present invention, and the left separated reinforcing main pipe 54b is included in the concept of a second separated reinforcing main pipe according to the present invention. Furthermore, the left reinforcing proximal end mounting part 58 is included in the concept of a second proximal end mounting part according to the present invention, and the left reinforcing distal end mounting part 60 is included in the concept of a second mounting part according to the present invention.

Moreover, the left reinforcing proximal end mounting part 58 is arranged so as to come into contact with a left side surface of the left foot part 22h. The left reinforcing proximal end mounting part 58 is provided with a through hole (not shown) that communicates with a foot hole (not shown) of the left foot part 22h in this state. The foot pin 23 is fitted and inserted into the through hole of the left reinforcing proximal end mounting part 58 and the through hole of the left foot part 22h. The foot pin 23 is provided on a left end thereof with a pinhead 23e whose diameter is larger than the through hole of the left reinforcing proximal end mounting part 58. The pinhead 23e abuts a left side surface of the left reinforcing proximal end mounting part 58. The screw part 23c of the detachment preventing member 23a is screwed and tightened into the screw hole 23d on the right end part of the foot pin 23. In this state, the left reinforcing proximal end mounting part 58 is pressed against the left side surface of the left foot part 22h by the pinhead 23e and thereby fixed to the left foot part 22h.

Moreover, by loosening the fastening of the screw part 23c of the detachment preventing member 23a to the screw hole 23d of the foot pin 23 and removing the detachment preventing member 23a from the foot pin 23, the foot pin 23 can be pulled out from the respective through holes of the right foot part 22g, the left foot part 22h, the right reinforcing proximal end mounting part 38, and the left reinforcing proximal end mounting part 58 to separate the right foot part 22g and the right reinforcing proximal end mounting part 38 from each other and also separate the left foot part 22h and left reinforcing proximal end mounting part 58 from each other.

Each left reinforcing distal end mounting part 60 is mounted by the coupling pin 21 to the left distal end connecting part 24k provided on the distal end part of the left intermediate unit pipe 24i adjacent on the tip side of the lattice boom 1 to the corresponding left foot unit pipe 22i, and also mounted by the coupling pin 21 to the left proximal end connecting part 24j provided on the proximal end part of another left intermediate unit pipe 24i adjacent on the tip side of the lattice boom 1 to the left intermediate unit pipe 24i. Moreover, the left distal end connecting part 24k provided on the distal end part of the left intermediate unit pipe 24i adjacent on the tip side of the lattice boom 1 to the left foot unit pipe 22i is included in the concept of a second distal end connecting part according to the present invention. In addition, the left proximal end connecting part 24j provided on the proximal end part of another left intermediate unit pipe 24i adjacent further on the tip side of the lattice boom 1 to the left intermediate unit pipe 24i is included in the concept of a second proximal end connecting part according to the present invention. Furthermore, the coupling pin 21 which connects the left distal end connecting part 24k and the left proximal end connecting part 24j to each other and which mounts the left reinforcing distal end mounting part 60 to both connecting parts 24k and 24j is included in the concept of a second coupling member according to the present invention.

The left reinforcing distal end mounting part 60 comprises a mounting plate part 60a similar to the mounting plate part 40a of the right reinforcing distal end mounting part 40. The mounting plate part 60a is provided with a left reinforcing mounting through hole (not shown) that is included in the concept of a second mounting through hole according to the present invention. The mounting plate part 60a of the left reinforcing distal end mounting part 60 sandwiches the sleeve 42 with the right receiving plate part 24n of the left distal end connecting part 24k. In this state, the pair of receiving plate parts 24n, the inserted part 24m, the sleeve 42, and the mounting plate part 60a are coupled by the coupling pin 21 and the cap 21c. The receiving plate part 24n and the inserted part 24m are respectively provided with through holes (not shown) that are included in the concept of a second mounted through hole according to the present invention. The coupling pin 21 is fitted and inserted into these through holes, the left reinforcing mounting through hole of the mounting plate part 60a, and the through hole of the sleeve 42. Such a structure is similar to a mirror-reversed structure of the coupling structure of the right reinforcing distal end mounting part 40, the receiving plate part 24h, the inserted part 24f, and the sleeve 42.

As described above, in the present first embodiment, the right reinforcing lattice member 4 is mounted to the right side surface of the base boom 2 such that when a load in an axial direction acts on the right main member 10a of the base boom 2, the load is transferred to the right reinforcing main pipe 34 that is arranged so as to separate outward from the right main member 10a, and the left reinforcing lattice member 6 is mounted to the left side surface of the base boom 2 such that when a load in an axial direction acts on the left main member 10b of the base boom 2, the load is transferred to the left reinforcing main pipe 54 that is arranged so as to separate outward from the left main member 10b. Therefore, when a bending load in a left-right direction (lateral direction) acts on the base boom 2 and thereby, for example, a compressive load in an axial direction acts on the right main member 10a, the right reinforcing main pipe 34 counteracts the load in addition to the right main member 10a, and when a compressive load in an axial direction acts on the left main member 10b, the left reinforcing main pipe 54 counteracts the load in addition to the left main member 10b. Accordingly, the bending strength and the bending stiffness of the lattice boom 1 with respect to a bending load in the left-right direction (lateral direction) can be increased and, as a result, deflection of the lattice boom 1 in the left-right direction (lateral direction) can be reduced.

In addition, in the present first embodiment, since both the right reinforcing lattice member 4 and the left reinforcing lattice member 6 have lattice structures, a high reinforcing effect can be obtained despite the weight. In other words, the bending stiffness of the lattice boom 1 in the left-right direction can be increased to suppress deflection of the lattice boom 1 in the left-right direction while avoiding a significant increase in the weight of the lattice boom 1.

Furthermore, in the present first embodiment, since the right reinforcing lattice member 4 and the left reinforcing lattice member 6 are attachable/detachable to/from the base boom 2, the width of the lattice boom 1 can be reduced during transportation of the lattice boom 1 by detaching both reinforcing lattice members 4 and 6 from the base boom 2. Moreover, when mounting the lattice boom 1 to the upper slewing body 104 of the crane to perform a crane operation, both reinforcing lattice members 4 and 6 can be mounted to the base boom 2 to increase the bending stiffness of the lattice boom 1 in the left-right direction and, as a result, deflection of the lattice boom 1 in the left-right direction can be suppressed. Therefore, in the present first embodiment, deflection of the lattice boom 1 in the left-right direction that occurs during a crane operation can be reduced while avoiding an increase in the width of the lattice boom 1 during transportation.

As described above, in the present first embodiment, deflection of the lattice boom 1 in the left-right direction that occurs during a crane operation can be reduced while avoiding a significant increase in the weight of the lattice boom 1 and avoiding an increase in width of the lattice boom 1 during transportation.

In addition, in the present first embodiment, the right reinforcing lattice member 4 is mounted in a region from a right foot part 22g of the foot of the base boom 2 to the right distal end connecting part 24e and the right proximal end connecting part 24d that are positioned more toward the foot than the middle in the longitudinal direction of the base boom 2, and the left reinforcing lattice member 6 is mounted in a region from a left foot part 22h of the foot of the base boom 2 to the left distal end connecting part 24k and the left proximal end connecting part 24j that are positioned more toward the foot than the middle in the longitudinal direction of the base boom 2. Therefore, in the present first embodiment, a range from a position more toward the foot than the intermediate part in the longitudinal direction of the base boom 2 to the foot of the base boom 2 can be reinforced and the lateral bending stiffness of the range can be increased. By increasing the lateral bending stiffness of such a range, for example, a displacement of the tip of the lattice boom 1 due to a lateral deflection of the lattice boom 1 can be reduced more effectively than, for example, a case where a stiffness of a range on the tip side of the intermediate part in the longitudinal direction of the lattice boom 1 is increased.

Furthermore, in the present first embodiment, the coupling pin 21 connects the right distal end connecting part 24e and the right proximal end connecting part 24d of the base boom 2 to each other and, at the same time, mounts the right reinforcing distal end mounting part 40 of the right reinforcing lattice member 4 to the right distal end connecting part 24e and the right proximal end connecting part 24d. Moreover, the coupling pin 21 connects the left distal end connecting part 24k and the left proximal end connecting part 24j to each other and, at the same time, mounts the left reinforcing distal end mounting part 60 of the left reinforcing lattice member 6 to the left distal end connecting part 24k and the left proximal end connecting part 24j. Therefore, the coupling pin 21 that connects the right distal end connecting part 24e and the right proximal end connecting part 24d can double as a coupling member for mounting the right reinforcing distal end mounting part 40 to the right distal end connecting part 24e and the right proximal end connecting part 24d, and the coupling pin 21 that connects the left distal end connecting part 24k and the left proximal end connecting part 24j can double as a coupling member for mounting the left reinforcing distal end mounting part 60 to the left distal end connecting part 24k and the left proximal end connecting part 24j. As a result, an increase in the number of parts can be suppressed.

In addition, in the present first embodiment, since the right reinforcing proximal end mounting part 38 of the right reinforcing lattice member 4 is mounted to the right foot part 22g and the left reinforcing proximal end mounting part 58 of the left reinforcing lattice member 6 is mounted to the left foot part 22h using the foot pin 23 for mounting the right foot part 22g and the left foot part 22h to the upper slewing body 104, an increase in the number of parts can be suppressed.

### Second Embodiment

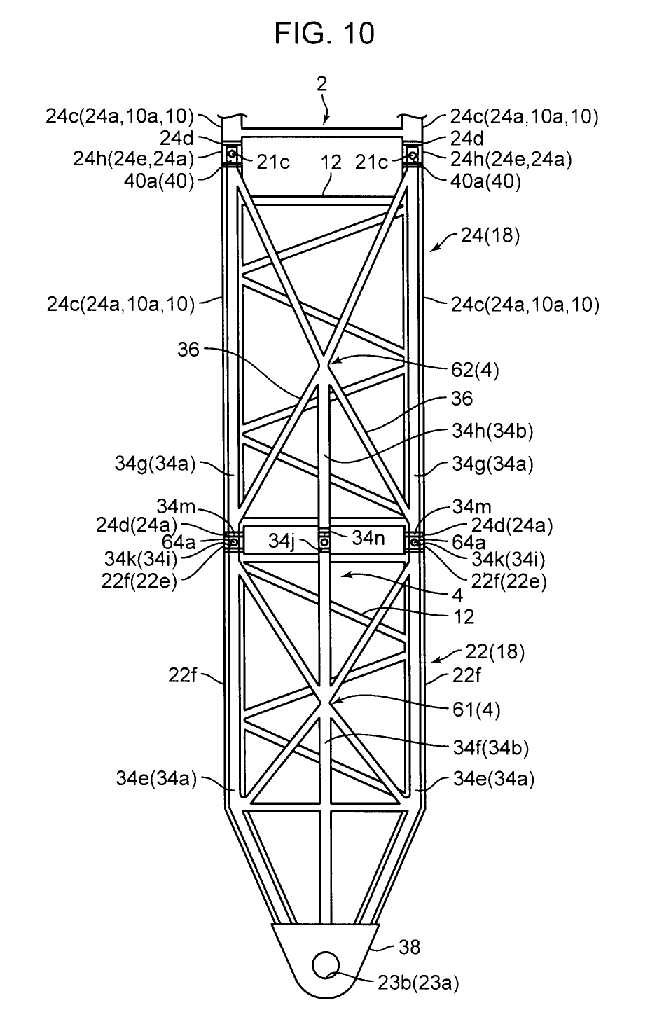

Next, a configuration of a lattice boom according to a second embodiment of the present invention will be described with reference to FIGS. 10 to 12.

In the lattice boom according to the present second embodiment, in addition to proximal end parts of reinforcing lattice members 4 and 6 being mounted to a boom foot 22a of a base boom 2 and distal end parts of the reinforcing lattice members 4 and 6 being mounted to a coupling part of intermediate unit booms 24 of the base boom 2, intermediate parts in a longitudinal direction of the reinforcing lattice members 4 and 6 are mounted to a coupling part of a boom foot unit boom 22 and an intermediate unit boom 24 adjacent on a distal end side of the boom foot unit boom 22 of the base boom 2.

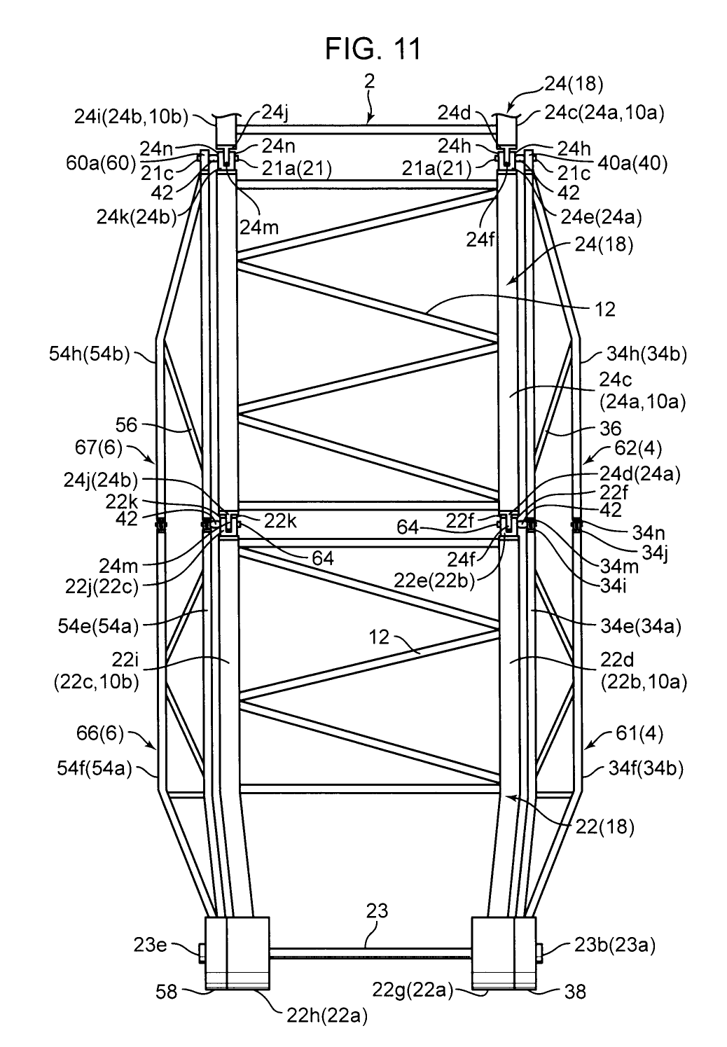

Specifically, as shown in FIGS. 10 and 11, the right reinforcing lattice member 4 comprises a right proximal end-side lattice part 61 and a right distal end-side lattice part 62. The right reinforcing lattice member 4 splits into the right proximal end-side lattice part 61 and the right distal end-side lattice part 62 at the middle in a longitudinal direction of the right reinforcing lattice member 4. In other words, in the present second embodiment, a right adjacent reinforcing main pipe 34a and a right separated reinforcing main pipe 34b are split at the middle in longitudinal directions thereof. The right proximal end-side lattice part 61 comprises a right proximal end-side adjacent reinforcing main pipe part 34e corresponding to a proximal end-side portion of the right adjacent reinforcing main pipe 34a split into two, and a right proximal end-side separated reinforcing main pipe part 34f corresponding to a proximal end-side portion of the right separated reinforcing main pipe 34b split into two. In addition, the right distal end-side lattice part 62 comprises a right distal end-side adjacent reinforcing main pipe part 34g corresponding to a distal end-side portion of the right adjacent reinforcing main pipe 34a split into two, and a right distal end-side separated reinforcing main pipe part 34h corresponding to a distal end-side portion of the right separated reinforcing main pipe 34b split into two.

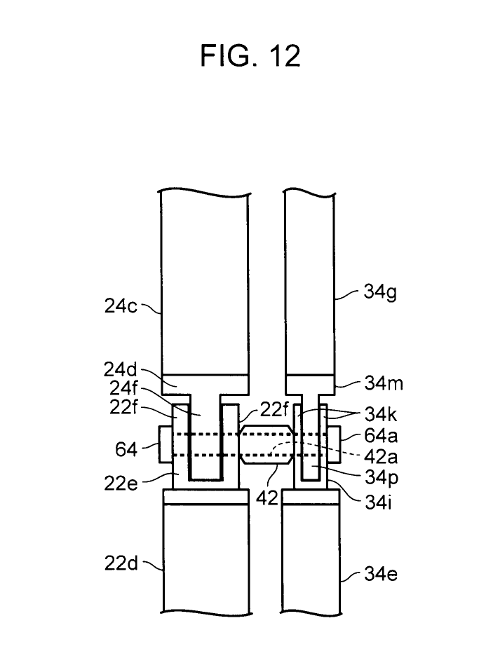

In addition, the right proximal end-side lattice part 61 comprises a right adjacent reinforcing main pipe connecting part 34i provided on a distal end of the right proximal end-side adjacent reinforcing main pipe part 34e, and a right separated reinforcing main pipe connecting part 34j provided on a distal end of the right proximal end-side separated reinforcing main pipe part 34f. The right adjacent reinforcing main pipe connecting part 34i and the right separated reinforcing main pipe connecting part 34j have structures similar to the right distal end connecting part 24e. In other words, the right adjacent reinforcing main pipe connecting part 34i comprises a pair of receiving plate parts 34k (refer to FIG. 12) similar to the pair of receiving plate parts 24h of the right distal end connecting part 24e, and the right separated reinforcing main pipe connecting part 34j comprises a similar pair of receiving plate parts.

The right distal end-side lattice part 62 comprises a right adjacent reinforcing main pipe connected part 34m provided on a proximal end of the right distal end-side adjacent reinforcing main pipe part 34g, and a right separated reinforcing main pipe connected part 34n provided on a proximal end of the right distal end-side separated reinforcing main pipe part 34h. The right adjacent reinforcing main pipe connected part 34m and the right separated reinforcing main pipe connected part 34n have structures similar to the right proximal end connecting part 24d. In other words, the right adjacent reinforcing main pipe connected part 34m comprises an inserted part 34p similar to the inserted part 24f of the right proximal end connecting part 24d, and the right separated reinforcing main pipe connected part 34n comprises a similar inserted part.

The inserted part 34p of the right adjacent reinforcing main pipe connected part 34m is inserted between the pair of receiving plate parts 34k of the right adjacent reinforcing main pipe connecting part 34i, and a sleeve 42 is sandwiched between the left receiving plate part 34k of the right adjacent reinforcing main pipe connecting part 34i and the right receiving plate part 22f of the right distal end connecting part 22e of the boom foot unit boom 22. In this state, a coupling pin 64 is fitted and inserted into through holes respectively provided on the pair of receiving plate parts 22f of the boom foot unit boom 22 and the inserted part 24f of the intermediate unit booms 24 inserted between the receiving plate parts 22f, the sleeve 42, and the pair of receiving plate parts 34k of the right proximal end-side lattice part 61 and the inserted part 34p of the right distal end-side lattice part 62 inserted between the receiving plate parts 34k. A cap 64a is mounted to a right end part of the coupling pin 64. A structure regarding the coupling pin 64 and the cap 64a is similar to the structure regarding the coupling pin 21 and the cap 21c according to the first embodiment described earlier.

In addition, the right separated reinforcing main pipe connecting part 34j and the right separated reinforcing main pipe connected part 34n are coupled to each other by a coupling structure that is similar to the coupling structure according to the first embodiment described earlier in which the pair of receiving plate parts 22f of the right distal end connecting part 22e and the inserted part 24f of the right proximal end connecting part 24d are coupled by the coupling pin 20.

During transportation of the lattice boom, by removing the cap 64a from the coupling pin 64 and pulling out the coupling pin 64 from the respective through holes, the coupling between the right adjacent reinforcing main pipe connecting part 34i and the right adjacent reinforcing main pipe connected part 34m can be released and, at the same time, fixing of the right adjacent reinforcing main pipe connecting part 34i and the right adjacent reinforcing main pipe connected part 34m to the base boom 2 can also be released. In addition, by a similar method, the coupling between the right separated reinforcing main pipe connecting part 34j and the right separated reinforcing main pipe connected part 34n can be released. Due to such a method, during transportation of a lattice boom, the right reinforcing lattice member 4 can be separated from the base boom 2 and, at the same time, the right reinforcing lattice member 4 can be dismantled into the right proximal end-side lattice part 61 and the right distal end-side lattice part 62.

Furthermore, the left reinforcing lattice member 6 has a structure that is a mirror-reversed structure of the right reinforcing lattice member 4. The left reinforcing lattice member 6 comprises a left proximal end-side lattice part 66 and a left distal end-side lattice part 67 which have structures that are mirror-reversed structures of the right proximal end-side lattice part 61 and the right distal end-side lattice part 62 of the right reinforcing lattice member 4. Mounting structures of the left proximal end-side lattice part 66 and a left distal end-side lattice part 67 to the base boom 2 are similar to a mirror-reversed structure of the mounting structures of the right proximal end-side lattice part 61 and the right distal end-side lattice part 62 to the base boom 2.

A configuration of the lattice boom according to the present second embodiment other than those described above is similar to the configuration of the lattice boom 1 according to the first embodiment described earlier.

As described above, in the present second embodiment, since the reinforcing lattice members 4 and 6 are mounted to the base boom 2 not only at distal end parts and proximal end parts but also at intermediate parts in the longitudinal directions of the reinforcing lattice members 4 and 6, a coupling strength of the reinforcing lattice members 4 and 6 to the base boom 2 can be increased.

In addition, in the present second embodiment, since the reinforcing lattice members 4 and 6 are divisible at the middle in the longitudinal directions of the reinforcing lattice members 4 and 6, during transportation of the lattice boom, the reinforcing lattice members 4 and 6 can be transported after respectively dividing the reinforcing lattice members 4 and 6 at the middle in the longitudinal directions thereof to reduce length. Therefore, transportability of the lattice boom can be further improved.

Advantages of the lattice boom according to the present second embodiment other than those described above are similar to the advantages of the lattice boom 1 according to the first embodiment described earlier.

### Third Embodiment

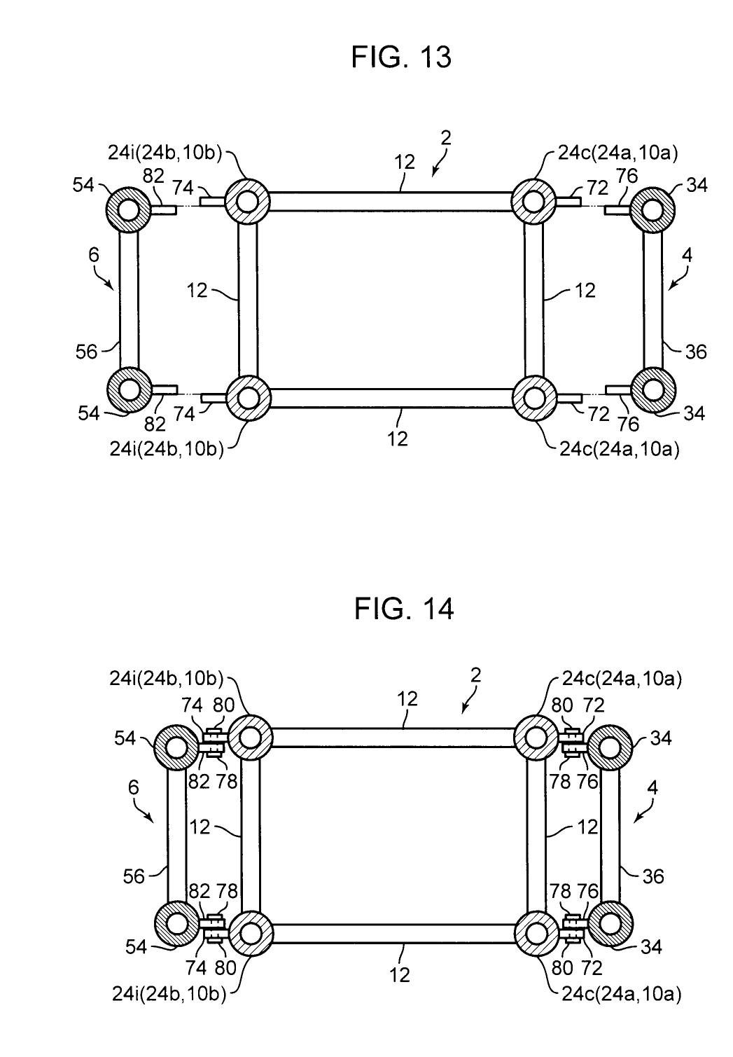

Next, a configuration of a lattice boom according to a third embodiment of the present invention will be described with reference to FIGS. 13 to 15.

The lattice boom according to the present third embodiment differs from the respective embodiments described above in fundamental structures of reinforcing lattice members 4 and 6 and in mounting structures of the reinforcing lattice members 4 and 6 to a base boom 2.

Specifically, in the lattice boom according to the present third embodiment, each right main member 10a of the base boom 2 comprises a plurality of right mounted plates 72 and each left main member 10b of the base boom 2 comprises a plurality of left mounted plates 74. The right mounted plates 72 are included in the concept of a first mounted plate according to the present invention, and the left mounted plates 74 are included in the concept of a second mounted plate according to the present invention.

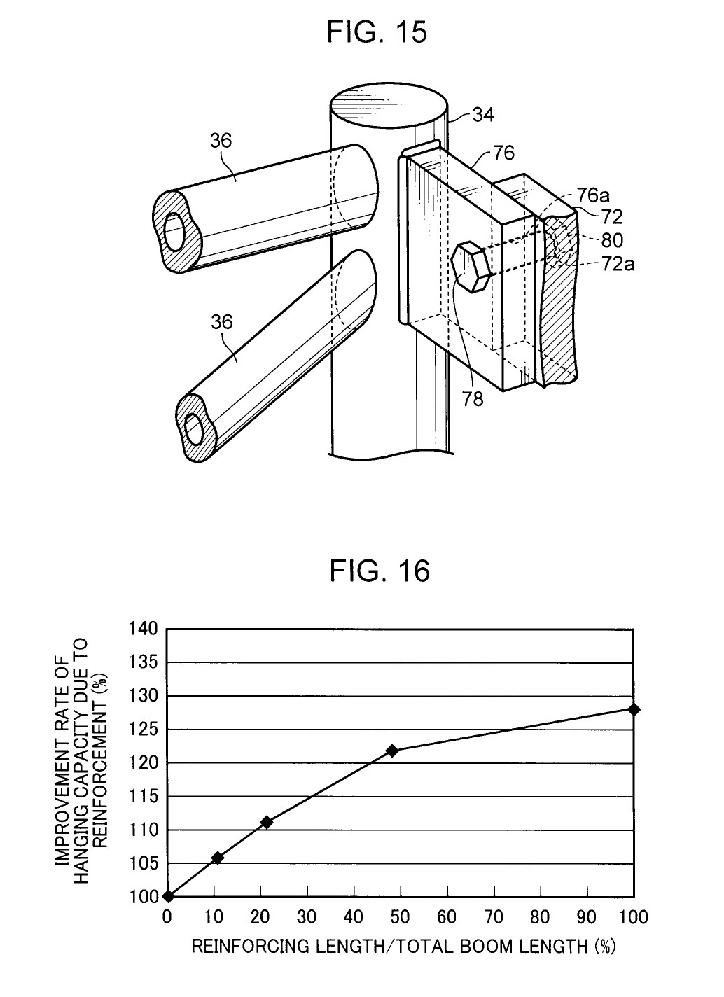

As shown in FIG. 13, the right mounted plates 72 are provided on, for example, a right intermediate unit pipe 24c among the respective right main members 10a. The right intermediate unit pipe 24c is included in the concept of a first main pipe according to the present invention. Each right mounted plate 72 is constituted by a flat plate-like member provided so as to follow a longitudinal direction of the right intermediate unit pipe 24c. Each right mounted plate 72 protrudes rightward perpendicularly to a right side surface of the base boom 2 from a portion positioned right outward of the base boom 2 among an outer circumferential surface of the right intermediate unit pipe 24c. Moreover, although not shown, the right mounted plates 72 are respectively disposed at two locations separated from each other in a longitudinal direction (axial direction) among the respective right main members 10a. Each right mounted plate 72 is provided with a right mounted through hole 72a (refer to FIG. 15) that penetrates the right mounted plate 72 in a thickness direction. The right mounted through hole 72a is included in the concept of a first mounted through hole according to the present invention.

In addition, the left mounted plates 74 are provided on, for example, a left intermediate unit pipe 24i among the respective left main members 10b. The left intermediate unit pipe 24i is included in the concept of a second main pipe according to the present invention. Each left mounted plate 74 is constituted by a flat plate-like member provided so as to follow a longitudinal direction of the left intermediate unit pipe 24i. Each left mounted plate 74 protrudes leftward perpendicularly to a left side surface of the base boom 2 from a portion positioned left outward of the base boom 2 among an outer circumferential surface of the left intermediate unit pipe 24i. In the same manner as the right mounted plates 72, the left mounted plates 74 are respectively disposed at two locations separated from each other in a longitudinal direction among the respective left main members 10b. Each left mounted plate 74 is provided with a left mounted through hole (not shown) which is similar to the right mounted through hole 72a of the right mounted plates 72. The left mounted through hole is included in the concept of a second mounted through hole according to the present invention.

Moreover, installation positions of the mounted plates 72 or 74 in the longitudinal directions of the respective main members 10 are the same. In addition, installation positions of all mounted plates 72 and 74 are toward a foot side than an intermediate part in the longitudinal direction of the base boom 2.

The right reinforcing lattice member 4 comprises two right reinforcing main pipes 34, a plurality of right reinforcing sub pipes 36, and a plurality of right mounting plates 76.

The two right reinforcing main pipes 34 are separated from each other in a same direction as the direction in which the two right main members 10a of the base boom 2 are separated from each other and by a distance approximately the same as the distance by which the two right main members 10a are separated from each other. Each right reinforcing main pipe 34 is constituted by a round pipe. Each right reinforcing main pipe 34 is arranged so as to extend along a corresponding right main member 10a among the two right main members 10a of the base boom 2 on an outer right side of the corresponding right main member 10a.

The plurality of right reinforcing sub pipes 36 is arranged between the two right reinforcing main pipes 34 and couple the two right reinforcing main pipes 34 to each other. A lattice structure is formed between the two right reinforcing main pipes 34 by the right reinforcing sub pipes 36.

Each right mounting plate 76 is a part mounted to a corresponding right mounted plate 72 of the base boom 2. The right mounting plate 76 is included in the concept of a first mounting plate according to the present invention. The right mounting plate 76 is respectively provided on the two right reinforcing main pipes 34. Each right mounting plate 76 is constituted by a flat plate-like member provided so as to protrude from an outer circumferential surface of the right reinforcing main pipe 34 and to follow a longitudinal direction of the right reinforcing main pipe 34. Each right mounting plate 76 protrudes leftward perpendicularly to a surface formed by the plurality of right reinforcing sub pipes 36 from a portion facing to a side of the right side surface of the base boom 2 among an outer circumferential surface of the right reinforcing main pipe 34. Moreover, although not shown, the right mounting plates 76 are respectively provided at two locations separated from each other in a longitudinal direction (axial direction) among the respective right reinforcing main pipes 34. The right mounting plates 76 are arranged at positions corresponding to the right mounted plates 72. Each right mounting plate 76 is provided with a right mounting through hole 76a (refer to FIG. 15) that penetrates the right mounting plate 76 in a thickness direction. The right mounting through hole 76a is included in the concept of a first mounting through hole according to the present invention.

In addition, as shown in FIG. 14, in a state where each of the right mounted plates 72 respectively provided on the two right main members 10a of the base boom 2 is overlapped with a corresponding right mounting plate 76 of the right reinforcing lattice member 4, the respective right mounted plates 72 and corresponding right mounting plates 76 are fixed to each other by having bolts 78 respectively fitted and inserted into right mounting through holes 76a that communicate with the respective right mounted through holes 72a (FIG. 15) and having nuts 80 respectively screwed and tightened on the respective bolts 78. Moreover, the bolt 78 that fixes the right mounted plate 72 and the right mounting plate 76 to each other is included in the concept of a first coupling member according to the present invention.

Furthermore, the left reinforcing lattice member 6 has a structure that is a mirror-reversed structure of the right reinforcing lattice member 4. Specifically, the left reinforcing lattice member 6 comprises two left reinforcing main pipes 54, a plurality of left reinforcing sub pipes 56, and a left mounting plate 82 which are mirror reversals of the two right reinforcing main pipes 34, the plurality of right reinforcing sub pipes 36, and the right mounting plate 76 of the right reinforcing lattice member 4. The left mounting plate 82 is a part mounted to the left mounted plate 74 of the base boom 2. The left mounting plate 82 is included in the concept of a second mounting plate according to the present invention.

In the present third embodiment, a mounting structure of the left reinforcing lattice member 6 to the base boom 2 is a mirror-reversed structure of the mounting structure of the right reinforcing lattice member 4 to the base boom 2. Specifically, in a state where the left mounting plate 82 of the left reinforcing lattice member 6 is overlapped with the left mounted plate 74 provided on the left main member 10b, the left mounted plate 74 and the left mounting plate 82 are fixed to each other by having the bolt 78 respectively fitted and inserted into a left mounted through hole (not shown) provided on the left mounted plate 74 and a left mounting through hole (not shown) provided on the left mounting plate 82 and having the nut 80 screwed and tightened on the bolt 78. Moreover, the bolt 78 that fixes the left mounted plate 74 and the left mounting plate 82 to each other is included in the concept of a second coupling member according to the present invention.

A configuration of the lattice boom according to the present third embodiment other than those described above is similar to the configuration of the lattice boom 1 according to the first embodiment described earlier.

In the present third embodiment, the bolt 78 extending in a direction perpendicular to the direction in which the right main member 10a of the base boom 2 extends is fitted and inserted into the right mounting through hole 76a provided on the right mounting plate 76 of the right reinforcing lattice member 4 and the right mounted through hole 72a provided on the right mounted plate 72 of the base boom 2 and the right mounting plate 76 and the right mounted plate 72 are fixed to each other by the bolt 78 and the nut 80 and, at the same time, the bolt 78 extending in a direction perpendicular to the direction in which the left main member 10b of the base boom 2 extends is fitted and inserted into the left mounting through hole provided on the left mounting plate 82 of the left reinforcing lattice member 6 and the left mounted through hole provided on the left mounted plate 74 of the base boom 2 and the left mounting plate 82 and the left mounted plate 74 are fixed to each other by the bolt 78 and the nut 80. As a result, when a bending load in a left-right direction acts on the lattice boom and a load in an axial direction acts on the right main member 10a of the base boom 2, the load can be effectively transferred from the right mounted plate 72 to the right mounting plate 76 via the bolt 78 and also from the right mounting plate 76 to the right reinforcing main pipe 34. In addition, when a bending load in a left-right direction acts on the lattice boom and a load in an axial direction acts on the left main member 10b of the base boom 2, the load can be effectively transferred from the left mounted plate 74 to the left mounting plate 82 via the bolt 78 and also from the left mounting plate 82 to the left reinforcing main pipe 54.

Advantages of the lattice boom according to the present third embodiment other than those described above are similar to the advantages of the lattice boom 1 according to the first embodiment described earlier.

(Simulation of Reinforcing Effect Obtained According to Reinforcing Length of Lattice Boom)

Next, a description will be given on a result of a simulation for studying a relationship between a length in which reinforcement is performed (hereinafter, referred to as reinforcing length) among a portion from a foot part toward a tip side of a lattice boom and a reinforcing effect obtained by the reinforcement. In the simulation, an improvement trend in the reinforcement effect is examined by studying how a hanging capacity of a lattice boom improves when varying a reinforcing length from a foot part toward a tip side of the boom. Moreover, the simulation assumes that the lattice boom is to be reinforced by increasing a thickness of main members of the lattice boom. However, the improvement trend in the reinforcement effect with respect to reinforcing length as obtained by the simulation conceivably should also be manifested when reinforcement is performed using reinforcing lattice members as in the respective embodiments described above.

In FIG. 16, an abscissa represents a ratio of reinforcing length from the foot part toward the tip side of the boom with respect to a total length of the boom, and an ordinate represents an improvement rate of a hanging capacity of the boom due to reinforcement. Moreover, the hanging capacity of the boom in the present simulation is expressed by a suspended load acted on the boom. Specifically, the hanging capacity signifies a suspended load regulated such that a lateral deflection of the boom stays within 2% or less of the total length of the boom when a lateral load equivalent to 2% of the suspended load acts on a tip of the boom. In addition, the improvement rate of the hanging capacity of the boom due to reinforcement illustrated on the ordinate in FIG. 16 represents a ratio of a hanging capacity of the boom after reinforcement with respect to a hanging capacity of the boom in a state where reinforcement is not implemented, with 100% representing the hanging capacity of an unreinforced boom.

FIG. 16 shows that when the ratio of the reinforcing length with respect to the total length of the boom is 50% or less, the hanging capacity of the boom improves approximately in direct proportion to an increase in reinforcing length, but when the ratio of the reinforcing length with respect to the total length of the boom exceeds 50%, the hanging capacity of the boom does not improve noticeably despite an increase in reinforcing length. From this result, it was found that intensively reinforcing a region toward a proximal end (foot part) side from an intermediate part in the longitudinal direction of the boom is effective in efficiently suppressing lateral deflection of the boom and contributes significantly toward improving the hanging capacity of the boom.

Moreover, the embodiments disclosed herein should be considered to be illustrative and not restrictive in all aspects thereof The scope of the present invention is to be defined by the following claims and not by the description of the embodiments presented above, and is intended to include meanings equivalent to the following claims and all modifications within the following claims.

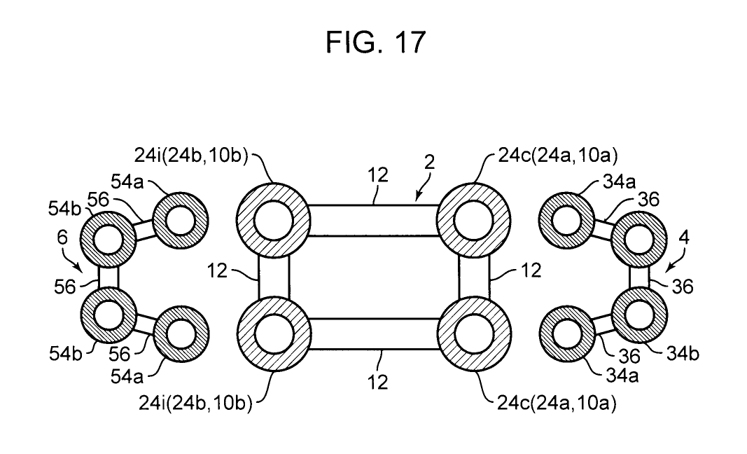

For example, as in a case of a first modification of the aforementioned first embodiment shown in FIG. 17, the right reinforcing lattice member 4 may comprise a plurality of right separated reinforcing main pipes 34b and the left reinforcing lattice member 6 may comprise a plurality of left separated reinforcing main pipes 54b. Specifically, in the present first modification, two right separated reinforcing main pipes 34b are arranged in the right reinforcing lattice member 4 so as to be separated right outward of the two right adjacent reinforcing main pipes 34a. Each right separated reinforcing main pipe 34b is coupled to a corresponding right adjacent reinforcing main pipe 34a by a right reinforcing sub pipe 36. The two right separated reinforcing main pipes 34b are coupled to each other by the right reinforcing sub pipe 36 arranged between the right separated reinforcing main pipes 34b. The left reinforcing lattice member 6 has a structure that is a mirror-reversed structure of the right reinforcing lattice member 4.

In addition, instead of the right adjacent reinforcing main pipe 34a and the left adjacent reinforcing main pipe 54a which are constituted by round pipes, members with shapes other than a round pipe may be used as the main pipes.

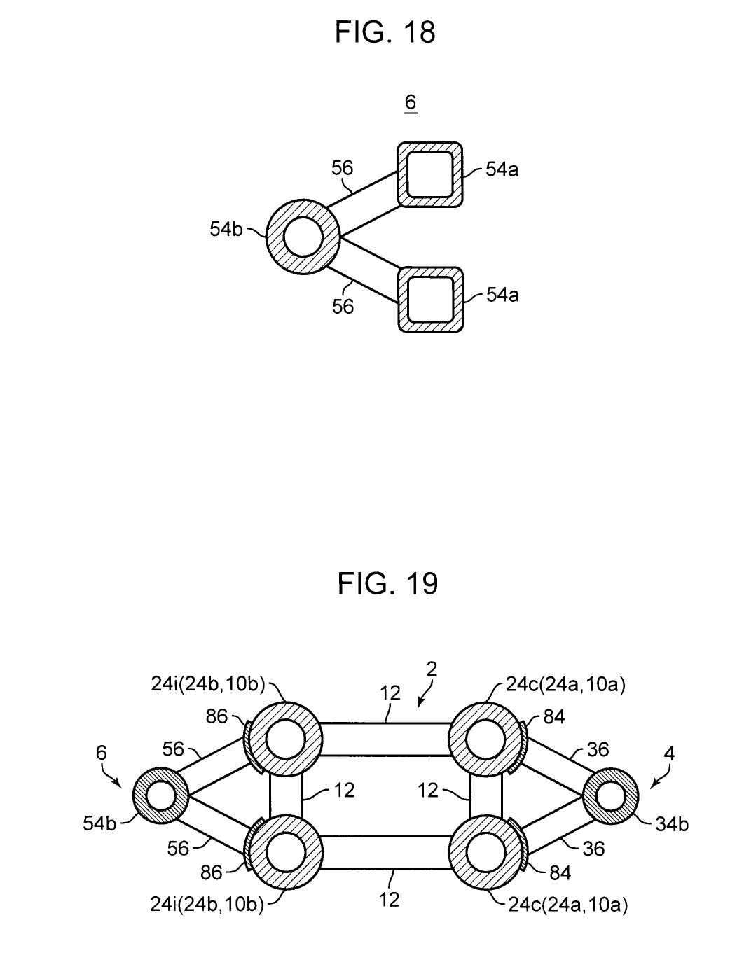

For example, as in a case of a second modification of the aforementioned first embodiment shown in FIG. 18, a left adjacent reinforcing main pipe 54a constituted by a square pipe may be used in the left reinforcing lattice member 6. Similarly, a right adjacent reinforcing main pipe 34a constituted by a square pipe may be used in the right reinforcing lattice member 4.

In addition, as in a case of a third modification of the aforementioned first embodiment shown in FIG. 19, a right adjacent reinforcing member 84 constituted by a plate material which bends along an outer circumferential surface of the right main member 10a constituted by a round pipe among the base boom 2 and which extends in the longitudinal direction of the right main member 10a may be provided instead of the right adjacent reinforcing main pipe 34a, and a left adjacent reinforcing member 86 constituted by a plate material which bends along an outer circumferential surface of the left main member 10b constituted by a round pipe among the base boom 2 and which extends in the longitudinal direction of the left main member 10b may be provided instead of the left adjacent reinforcing main pipe 54a. Moreover, while the right adjacent reinforcing member 84 and the left adjacent reinforcing member 86 may be provided so as to extend along the main members 10a and 10b across entire arrangement regions of the reinforcing lattice members 4 and 6, favorably, short adjacent reinforcing members 84 and 86 are disposed at each location of the base boom 2 where the sub members 12 are joined to the main members 10a and 10b and the adjacent reinforcing members 84 and 86 are in contact with the main members 10a and 10b at the respective locations. In this case, the adjacent reinforcing members 84 and 86 may be respectively coupled to the separated reinforcing main pipes 34b and 54b by a corresponding reinforcing sub pipe 36 or 56.

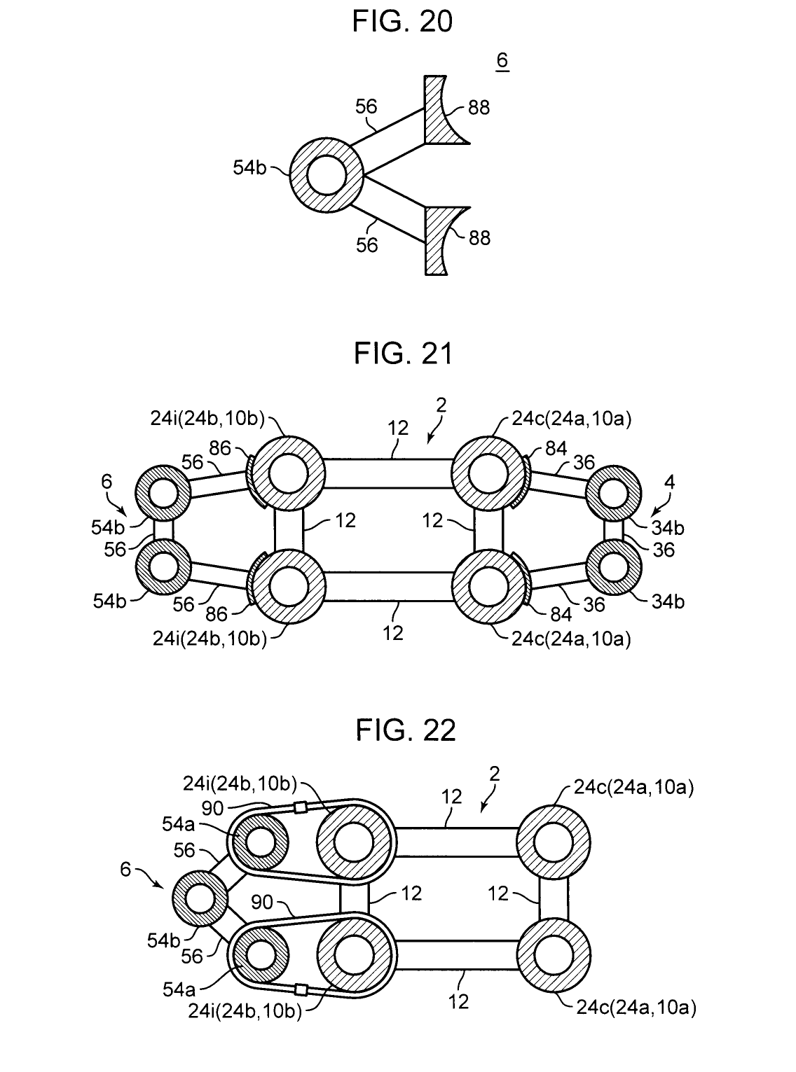

Furthermore, when adjacent reinforcing members are provided so as to follow the outer circumferential surfaces of the left and right main members 10a and 10b, shapes of the adjacent reinforcing members are not limited to a bent plate shape as in the case of the adjacent reinforcing members 84 and 86 according to the third modification shown in FIG. 19. For example, as shown in FIG. 20, a left adjacent reinforcing member 88 may be used which is constituted by a solid member whose surface to come into contact with the left main member 10b is formed as a curved surface that curves along the outer circumferential surface of the left main member 10b and whose surface to be welded to the left reinforcing sub pipe 56 is formed in a planar shape. In addition, a right adjacent reinforcing member may be used which is constituted by a solid member whose surface to come into contact with the right main member 10a is formed as a curved surface that curves along the outer circumferential surface of the right main member 10a and whose surface to be welded to the right reinforcing sub pipe 36 is formed in a planar shape. Moreover, the left adjacent reinforcing member and the right adjacent reinforcing member may be formed as hollow pipes having the external shapes described herein.

Furthermore, the reinforcing lattice members 4 and 6 may combine features of the reinforcing lattice members 4 and 6 according to the first modification described above and features of the reinforcing lattice members 4 and 6 according to the third modification described above. Specifically, as in a case of a fifth modification of the aforementioned first embodiment shown in FIG. 21, the right reinforcing lattice member 4 may comprise a plurality of right separated reinforcing main pipes 34b as well as a curved plate-like right adjacent reinforcing member 84 instead of the right adjacent reinforcing main pipe 34a, and the left reinforcing lattice member 6 may comprise a plurality of left separated reinforcing main pipes 54b as well as a curved plate-like left adjacent reinforcing member 86 instead of the left adjacent reinforcing main pipe 54a.

In addition, as in a case of a sixth modification of the aforementioned first embodiment shown in FIG. 22, the left adjacent reinforcing main pipe 54a arranged along the left main member 10b of the base boom 2 may be supplementarily bound to the left main member 10b by a band 90 such as a steel band. Moreover, although not shown in FIG. 22, the right adjacent reinforcing main pipe 34a may similarly be bound to the right main member 10a of the base boom 2 by a band. Furthermore, an adjacent reinforcing main pipe arranged along a main member 10 of the base boom 2 may be tightened and fixed to the main member 10 by some kind of clamping equipment instead of a band.

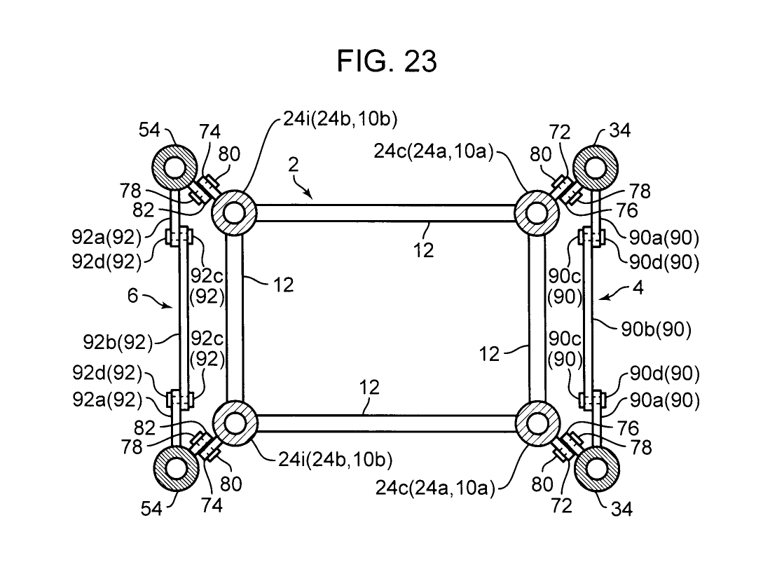

In addition, as in a case of a modification of the aforementioned third embodiment shown in FIG. 23, the mounted plates 72 and 74 of the base boom 2 may be provided so as protrude obliquely outward from the main members 10, and the mounting plates 76 and 82 of the reinforcing lattice members 4 and 6 may be provided so as protrude obliquely from the reinforcing main pipes 34 and 54 toward the side of the base boom 2 and inward in width directions of the reinforcing lattice members 4 and 6.

Furthermore, in the present modification, the two right reinforcing main pipes 34 are coupled to each other by a right inter-pipe coupling member 90 in which a plurality of plate members is joined together, and the two left reinforcing main pipes 54 are coupled to each other by a left inter-pipe coupling member 92 in which a plurality of plate members is joined together.

Specifically, the right inter-pipe coupling member 90 comprises plate-like right pipe mounting members 90a respectively welded to the right reinforcing main pipes 34, a plate-like right intermediate member 90b for connecting the right pipe mounting members 90a to each other, bolts 90c, and nuts 90d. The right pipe mounting members 90a are respectively welded to positions that oppose each other among outer circumferential surfaces of the two right reinforcing main pipes 34. The right pipe mounting members 90a respectively welded to the two right reinforcing main pipes 34 extend in directions in which the right pipe mounting members 90a approach each other. In addition, the right intermediate member 90b is disposed so as to form a bridge between distal ends of the respective right pipe mounting members 90a, and each end part of the right intermediate member 90b is fastened to a distal end part of a corresponding right pipe mounting member 90a by the bolt 90c and the nut 90d.

The left inter-pipe coupling member 92 has a structure that is a mirror-reversed structure of the right inter-pipe coupling member 90. The left inter-pipe coupling member 92 comprises two left pipe mounting members 92a, a left intermediate member 92b, bolts 92c, and nuts 92d corresponding to the two right pipe mounting members 90a, the right intermediate member 90b, the bolts 90c, and the nuts 90d of the right inter-pipe coupling member 90.

As in the present modification, when the pipe mounting members 90a and 92a and the intermediate members 90b and 92b are fastened by the bolts 90c and 92c and the nuts 90d and 92d, the reinforcing lattice members 4 and 6 can be readily disassembled and assembled at a crane operation site or the like.

Furthermore, mounting of the reinforcing lattice members need not be limited to a region toward a foot side from the middle in a longitudinal direction of a base boom. For example, the reinforcing lattice members may be mounted across an entire longitudinal length of the base boom. However, from the perspectives of achieving effective reduction of deflection of a lattice boom while suppressing an increase in weight of the boom, the reinforcing lattice members are favorably mounted to a partial region in a longitudinal direction of the base boom and distances in the longitudinal direction of the base boom between proximal ends of the reinforcing lattice members and a foot of the base boom are favorably smaller than distances in the longitudinal direction of the base boom between distal ends of the reinforcing lattice members and a tip of the base boom.

Moreover, a lattice boom according to the present invention may be provided on various types of cranes besides a crawler crane.

### Summary of Embodiments

The embodiments described above can be summarized as follows.

A lattice boom according to the embodiments described above is a lattice boom provided on a rotatable main body of a crane so as to be freely raised and lowered, the lattice boom comprising: a base boom including a lattice structure which extends in a specific direction and which has a first side surface facing a rotating direction of the main body of the crane and a second side surface opposite to the first side surface, with a foot of the base boom being mounted on the main body of the crane, and a tip of the base boom from which a suspended load is to be hung; a first reinforcing lattice member which is arranged so as to extend along a longitudinal direction of the base boom, and which is attachable/detachable to/from the first side surface of the base boom, and moreover which has a lattice structure; and a second reinforcing lattice member which is arranged so as to extend along the longitudinal direction of the base boom, and which is attachable/detachable to/from the second side surface of the base boom, and moreover which has a lattice structure, wherein the base boom includes a plurality of main members respectively having portions that extend in the longitudinal direction of the base boom, with the plurality of main members being separately arranged at positions corresponding to respective vertices of a square on a cross section perpendicular to the longitudinal direction of the base boom, and the main members including a first main member positioned on the first side surface and a second main member positioned on the second side surface, the first reinforcing lattice member includes a first reinforcing pipe which has a portion extending in a same direction as the first main member and which is separated outward from the first side surface of the base boom and a first mounting part which is provided on the first reinforcing pipe and which is mounted to the first main member so as to transfer a load acting on the first main member in an axial direction of the first main member to the first reinforcing pipe, and the second reinforcing lattice member includes a second reinforcing pipe which has a portion extending in a same direction as the second main member and which is separated outward from the second side surface of the base boom and a second mounting part which is provided on the second reinforcing pipe and which is mounted to the second main member so as to transfer a load acting on the second main member in an axial direction of the second main member to the second reinforcing pipe.

With this lattice boom, due to the first reinforcing lattice member and the second reinforcing lattice member, bending strength and bending stiffness of the lattice boom with respect to a lateral bending load can be increased to reduce lateral deflection of the lattice boom. Specifically, with this lattice boom, the first reinforcing lattice member is mounted to the first side surface of the base boom that faces a rotating direction of the crane main body such that when a load in an axial direction acts on the first main member of the base boom, the load is transferred to the first reinforcing pipe separated outward of the first main member, and the second reinforcing lattice member is mounted to the second side surface that is the opposite side surface to the first side surface of the base boom such that when a load in an axial direction acts on the second main member of the base boom, the load is transferred to the second reinforcing pipe separated outward of the second main member. Therefore, when a lateral bending load acts on the base boom and thereby, for example, a compressive load in an axial direction acts on the first main member, the first reinforcing pipe of the first reinforcing lattice member counteracts the load in addition to the first main member, and when a compressive load in an axial direction acts on the second main member, the second reinforcing pipe of the second reinforcing lattice member counteracts the load in addition to the second main member. As a result, the bending strength and the bending stiffness of the lattice boom with respect to a lateral bending load can be increased and, as a result, lateral deflection of the lattice boom can be reduced.

In addition, with this lattice boom, since both the first reinforcing lattice member and the second reinforcing lattice member have lattice structures, a high reinforcing effect can be obtained by the reinforcing lattice members despite the weight. In other words, the lateral bending stiffness of the lattice boom can be increased to suppress lateral deflection of the lattice boom while avoiding a significant increase in the weight of the lattice boom.

Furthermore, with this lattice boom, since the first reinforcing lattice member and the second reinforcing lattice member are attachable/detachable to/from the base boom, the width of the lattice boom can be reduced during transportation of the lattice boom by detaching both reinforcing lattice members from the base boom, and when mounting the lattice boom to a crane to perform a crane operation, both reinforcing lattice members can be mounted to the base boom to increase the lateral bending stiffness of the lattice boom and, consequently, suppressing lateral deflection of the lattice boom. In other words, with this lattice boom, lateral deflection of the lattice boom that occurs during a crane operation can be reduced while avoiding a significant increase in the width of the lattice boom during transportation.

Therefore, with this lattice boom, lateral deflection of the lattice boom that occurs during a crane operation can be reduced while avoiding a significant increase in the weight of the lattice boom and avoiding an increase in the width of the lattice boom during transportation.

With the lattice boom described above, favorably, the first main member comprises a first mounted part to which the first mounting part is to be mounted, the first mounted part is provided with a first mounted through hole that penetrates the first mounted part in a direction that intersects a direction in which the first main member extends, the first mounting part of the first reinforcing lattice member is provided with a first mounting through hole that penetrates the first mounting part in the same direction as the first mounted through hole, and a first coupling member that extends in a direction that intersects the direction in which the first main member extends is fitted into the first mounted through hole and the first mounting through hole to thereby allow the first mounting part to be mounted to the first mounted part.

Furthermore, with the lattice boom described above, favorably, the second main member comprises a second mounted part to which the second mounting part is to be mounted, the second mounted part is provided with a second mounted through hole that penetrates the second mounted part in a direction that intersects a direction in which the second main member extends, the second mounting part of the second reinforcing lattice member is provided with a second mounting through hole that penetrates the second mounting part in the same direction as the second mounted through hole, and a second coupling member that extends in a direction that intersects the direction in which the second main member extends is fitted into the second mounted through hole and the second mounting through hole to thereby allow the second mounting part to be mounted to the second mounted part.

In these configurations, since a mounted part of each main member of the base boom and a mounting part provided on a reinforcing pipe of a corresponding reinforcing lattice member are coupled by a coupling member extending in a direction that intersects the direction in which the main member of the base boom extends, when a load in an axial direction acts on the main member of the base boom, the load can be effectively transferred from the mounted part to the mounting part of the reinforcing lattice member via the coupling member and, at the same time, the load can be transferred from the mounting part to the reinforcing pipe. Therefore, according to these configurations, a specific structure can be constructed for mounting the respective reinforcing lattice members to the base boom so that when a load in an axial direction acts on the main member of the base boom, the load is transferred to the reinforcing pipe.

In the configuration in which the first mounting part is mounted to the first mounted part by having the first coupling member fitted and inserted into the first mounted through hole and the first mounting through hole, the first main member may comprise a plurality of first unit pipes arranged side by side in the longitudinal direction of the first main member, the first mounted part may comprise a first distal end connecting part provided on a distal end part of a predetermined first unit pipe among the plurality of first unit pipes and a first proximal end connecting part which is provided on a proximal end part of a different first unit pipe adjacent to the predetermined first unit pipe on a tip side of the lattice boom and which is connected to the first distal end connecting part, the first mounted through hole may be provided on the first distal end connecting part and the first proximal end connecting part, the first coupling member may be fitted into the first mounting through hole provided on the first mounting part and the first mounted through holes respectively provided on the first distal end connecting part and the first proximal end connecting part to thereby interconnect the first distal end connecting part and the first proximal end connecting part and allow the first mounting part to be mounted to the first distal end connecting part and the first proximal end connecting part.

With this configuration, due to the first coupling member, connecting parts respectively provided on a predetermined first unit pipe and on a different first unit pipe adjacent to the predetermined first unit pipe on a tip side of the lattice boom can be connected to each other, and the first mounting part of the first reinforcing lattice member can be mounted to the connecting parts. In other words, with this configuration, a coupling member for interconnecting connecting parts respectively provided on the two first unit pipes that are adjacent to each other can double as a coupling member for mounting the first mounting part of the first reinforcing lattice member to the first main member and, as a result, an increase in the number of parts can be suppressed.

Furthermore, in the configuration in which the second mounting part is mounted to the second mounted part by having the second coupling member fitted and inserted into the second mounted through hole and the second mounting through hole, the second main member may comprise a plurality of second unit pipes arranged side by side in the longitudinal direction of the second main member, the second mounted part may comprise a second distal end connecting part provided on a distal end part of a predetermined second unit pipe among the plurality of second unit pipes and a second proximal end connecting part which is provided on a proximal end part of a different second unit pipe adjacent to the predetermined second unit pipe on a tip side of the lattice boom and which is connected to the second distal end connecting part, the second mounted through hole may be provided on the second distal end connecting part and the second proximal end connecting part, the second coupling member may be fitted into the second mounting through hole provided on the second mounting part and the second mounted through holes respectively provided on the second distal end connecting part and the second proximal end connecting part to thereby interconnect the second distal end connecting part and the second proximal end connecting part and allow the second mounting part to be mounted to the second distal end connecting part and the second proximal end connecting part.

With this configuration, due to the second coupling member, connecting parts respectively provided on a predetermined second unit pipe and on a different second unit pipe adjacent to the predetermined second unit pipe on a tip side of the lattice boom can be connected to each other, and the second mounting part of the second reinforcing lattice member can be mounted to the connecting parts. In other words, with this configuration, a coupling member for interconnecting connecting parts respectively provided on the two second unit pipes that are adjacent to each other can double as a coupling member for mounting the second mounting part of the second reinforcing lattice member to the second main member and, as a result, an increase in the number of parts can be suppressed.

In the configuration in which the first mounting part is mounted to the first mounted part by having the first coupling member fitted and inserted into the first mounted through hole and the first mounting through hole, the first main member may comprise a first main pipe that extends in a longitudinal direction of the base boom, the first mounted part may comprise a flat plate-like first mounted plate which is provided so as to protrude outward of the base boom from an outer circumferential surface of the first main pipe and which is provided along the longitudinal direction of the first main pipe, with the first mounted plate being provided with the first mounted through hole that penetrates the first mounted plate in a thickness direction of the first mounted plate, the first mounting part may comprise a flat plate-like first mounting plate which is provided so as to protrude from an outer circumferential surface of the first reinforcing pipe and which is provided along the longitudinal direction of the first reinforcing pipe, with the first mounting plate being provided with the first mounting through hole that penetrates the first mounting plate in a thickness direction of the first mounting plate, and the first coupling member may be fitted into the first mounting through hole and the first mounted through hole in a state where the first mounting plate is overlapped onto the first mounted plate to thereby allow the first mounting plate to be fixed to the first mounted plate.

According to this configuration, a specific structure can be constructed where the first mounting part is mounted to the first mounted part by having the first coupling member extending in a direction that intersects the direction in which the first main member of the base boom extends fitted and inserted into the first mounted through hole and the first mounting through hole.

In addition, in the configuration in which the second mounting part is mounted to the second mounted part by having the second coupling member fitted and inserted into the second mounted through hole and the second mounting through hole, the second main member may comprise a second main pipe that extends in a longitudinal direction of the base boom, the second mounted part may comprise a flat plate-like second mounted plate which is provided so as to protrude outward of the base boom from an outer circumferential surface of the second main pipe and which is provided along the longitudinal direction of the second main pipe, with the second mounted plate being provided with the second mounted through hole that penetrates the second mounted plate in a thickness direction of the second mounted plate, the second mounting part may comprise a flat plate-like second mounting plate which is provided so as to protrude from an outer circumferential surface of the second reinforcing pipe and which is provided along the longitudinal direction of the second reinforcing pipe, with the second mounting plate being provided with the second mounting through hole that penetrates the second mounting plate in a thickness direction of the second mounting plate, and the second coupling member may be fitted into the second mounting through hole and the second mounted through hole in a state where the second mounting plate is overlapped onto the second mounted plate to thereby allow the second mounting plate to be fixed to the second mounted plate.

According to this configuration, a specific structure can be constructed where the second mounting part is mounted to the second mounted part by having the second coupling member extending in a direction that intersects the direction in which the second main member of the base boom extends fitted and inserted into the second mounted through hole and the second mounting through hole.

In the lattice boom described above, favorably, the first reinforcing lattice member and the second reinforcing lattice member are mounted in a partial region in the longitudinal direction of the base boom, a distance in the longitudinal direction of the base boom between a proximal end of the first reinforcing lattice member and the foot of the base boom is smaller than a distance in the longitudinal direction of the base boom between a distal end of the first reinforcing lattice member and the tip of the base boom, and a distance in the longitudinal direction of the base boom between a proximal end of the second reinforcing lattice member and the foot of the base boom is smaller than a distance in the longitudinal direction of the base boom between a distal end of the second reinforcing lattice member and the tip of the base boom.

Generally, the higher the bending stiffness of a portion toward a foot from a middle part in the longitudinal direction of a boom and the less likely the portion is to deflect, the greater the effect of reducing displacement occurring at a tip of the boom when a load that causes deflection acts on the boom. Therefore, as is the case of the present configuration, when the first and second reinforcing lattice members are mounted in a partial region in the longitudinal direction of the base boom and distances in the longitudinal direction of the base boom between proximal ends of both reinforcing lattice members and the foot of the base boom is smaller than distances in the longitudinal direction of the base boom between distal ends of both reinforcing lattice members and the tip of the base boom, the bending stiffness of a portion relatively toward the foot among the lattice boom can be intensively increased and, as a result, displacement of the tip of the lattice boom attributable to deflection can be effectively reduced.

In this case, the base boom may comprise a first foot part which is arranged on the foot of the base boom and provided on the proximal end part of the first main member and which is mounted to the main body of the crane by a foot pin and a second foot part which is arranged on the foot of the base boom and provided on the proximal end part of the second main member and which is mounted to the main body of the crane by the foot pin, the first reinforcing lattice member may comprise a first proximal end mounting part which is arranged on the proximal end part of the first reinforcing lattice member and provided on the proximal end part of the first reinforcing pipe and which is mounted to the first foot part by the foot pin, the first mounting part may be mounted to a portion positioned further toward the tip side of the base boom than the first foot part among the first main member, the second reinforcing lattice member may comprise a second proximal end mounting part which is arranged on the proximal end part of the second reinforcing lattice member and provided on the proximal end part of the second reinforcing pipe and which is mounted to the second foot part by the foot pin, and the second mounting part may be mounted to a portion positioned further toward the tip side of the base boom than the second foot part among the second main member.

According to this configuration, a range from a predetermined position to a foot part positioned on the proximal end part in the longitudinal direction of the base boom can be reinforced by the first and second reinforcing lattice members. Therefore, a displacement of the tip of the lattice boom due to deflection can be reduced in an extremely effective manner. In addition, in this configuration, since proximal end mounting parts of corresponding reinforcing lattice members can be mounted to the respective foot parts using the foot pin for mounting both foot parts to the main body of the crane, an increase in the number of parts can be suppressed.

With the lattice boom described above, the two first main members may be disposed on the first side surface of the base boom so as to separate from each other in a direction perpendicular to the longitudinal direction of the base boom and the two second main members may be disposed on the second side surface of the base boom so as to separate from each other in a direction perpendicular to the longitudinal direction of the base boom, the first reinforcing pipe may comprise first adjacent reinforcing main pipes disposed respectively along the two first main members and first separated reinforcing main pipes which are disposed so as to separate, with respect to the first adjacent reinforcing main pipes, toward an opposite side to the first side surface and which include portions that extend in the longitudinal direction of the base boom, the first reinforcing lattice member may comprise first reinforcing sub pipes that connect the first adjacent reinforcing main pipes with the first separated reinforcing main pipes, the second reinforcing pipe may comprise second adjacent reinforcing main pipes disposed respectively along the two second main members and second separated reinforcing main pipes which are disposed so as to separate, with respect to the second adjacent reinforcing main pipes, toward an opposite side to the second side surface and which include portions that extend in the longitudinal direction of the base boom, and the second reinforcing lattice member may comprise second reinforcing sub pipes that connect the second adjacent reinforcing main pipes with the second separated reinforcing main pipes.

As shown, according to the embodiments described above, lateral deflection that occurs on a lattice boom during a crane operation can be suppressed while avoiding a significant increase in a weight of the lattice boom and an increase in a width of the lattice boom during transportation of the lattice boom.

This application is based on Japanese Patent application No. 2010-097965 filed in Japan Patent Office on Apr. 21, 2010, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A lattice boom provided on a rotatable main body of a crane so as to be freely raised and lowered, comprising:
a base boom including a lattice structure which extends in a specific direction and which has a first side surface facing a rotating direction of the main body of the crane and a second side surface opposite to the first side surface, with a foot of the base boom being mounted on the main body of the crane, and a tip of the base boom from which a suspended load is to be hung;
a first reinforcing lattice member which is arranged so as to extend along a longitudinal direction of the base boom, and which is attachable/detachable to/from the first side surface of the base boom, and moreover which has a lattice structure; and
a second reinforcing lattice member which is arranged so as to extend along the longitudinal direction of the base boom, and which is attachable/detachable to/from the second side surface of the base boom, and moreover which has a lattice structure, wherein
the base boom includes a plurality of main members respectively having portions that extend in the longitudinal direction of the base boom, with the plurality of main members being separately arranged at positions corresponding to respective vertices of a square on a cross section perpendicular to the longitudinal direction of the base boom, and the main members including a first main member positioned on the first side surface and a second main member positioned on the second side surface,
the first reinforcing lattice member includes a first reinforcing pipe which has a portion extending in a same direction as the first main member and which is separated outward from the first side surface of the base boom and a first mounting part which is provided on the first reinforcing pipe and which is mounted to the first main member so as to transfer a load acting on the first main member in an axial direction of the first main member to the first reinforcing pipe, and
the second reinforcing lattice member includes a second reinforcing pipe which has a portion extending in a same direction as the second main member and which is separated outward from the second side surface of the base boom and a second mounting part which is provided on the second reinforcing pipe and which is mounted to the second main member so as to transfer a load acting on the second main member in an axial direction of the second main member to the second reinforcing pipe.

2. The lattice boom according to claim 1, wherein
the first main member comprises a first mounted part to which the first mounting part is to be mounted,
the first mounted part is provided with a first mounted through hole that penetrates the first mounted part in a direction that intersects a direction in which the first main member extends,
the first mounting part of the first reinforcing lattice member is provided with a first mounting through hole that penetrates the first mounting part in the same direction as the first mounted through hole, and
a first coupling member that extends in a direction that intersects the direction in which the first main member extends is fitted into the first mounted through hole and the first mounting through hole to thereby allow the first mounting part to be mounted to the first mounted part.

3. The lattice boom according to claim 1, wherein
the second main member comprises a second mounted part to which the second mounting part is to be mounted,
the second mounted part is provided with a second mounted through hole that penetrates the second mounted part in a direction that intersects a direction in which the second main member extends,
the second mounting part of the second reinforcing lattice member is provided with a second mounting through hole that penetrates the second mounting part in the same direction as the second mounted through hole, and
a second coupling member that extends in a direction that intersects the direction in which the second main member extends is fitted into the second mounted through hole and the second mounting through hole to thereby allow the second mounting part to be mounted to the second mounted part.

4. The lattice boom according to claim 2, wherein
the first main member comprises a plurality of first unit pipes arranged side by side in the longitudinal direction of the first main member,
the first mounted part comprises a first distal end connecting part provided on a distal end part of a predetermined first unit pipe among the plurality of first unit pipes and a first proximal end connecting part which is provided on a proximal end part of a different first unit pipe adjacent to the predetermined first unit pipe on a tip side of the lattice boom and which is connected to the first distal end connecting part,
the first mounted through hole is provided on the first distal end connecting part and the first proximal end connecting part,
the first coupling member is fitted into the first mounting through hole provided on the first mounting part and the first mounted through holes respectively provided on the first distal end connecting part and the first proximal end connecting part to thereby interconnect the first distal end connecting part and the first proximal end connecting part and allow the first mounting part to be mounted to the first distal end connecting part and the first proximal end connecting part.

5. The lattice boom according to claim 3, wherein
the second main member comprises a plurality of second unit pipes arranged side by side in the longitudinal direction of the second main member,
the second mounted part comprises a second distal end connecting part provided on a distal end part of a predetermined second unit pipe among the plurality of second unit pipes and a second proximal end connecting part which is provided on a proximal end part of a different second unit pipe adjacent to the predetermined second unit pipe on a tip side of the lattice boom and which is connected to the second distal end connecting part,
the second mounted through hole is provided on the second distal end connecting part and the second proximal end connecting part,
the second coupling member is fitted into the second mounting through hole provided on the second mounting part and the second mounted through holes respectively provided on the second distal end connecting part and the second proximal end connecting part to thereby interconnect the second distal end connecting part and the second proximal end connecting part and allow the second mounting part to be mounted to the second distal end connecting part and the second proximal end connecting part.

6. The lattice boom according to claim 2, wherein
the first main member comprises a first main pipe that extends in a longitudinal direction of the base boom,
the first mounted part comprises a flat plate-like first mounted plate which is provided so as to protrude outward of the base boom from an outer circumferential surface of the first main pipe and which is provided along the longitudinal direction of the first main pipe, with
the first mounted plate being provided with the first mounted through hole that penetrates the first mounted plate in a thickness direction of the first mounted plate,
the first mounting part comprises a flat plate-like first mounting plate which is provided so as to protrude from an outer circumferential surface of the first reinforcing pipe and which is provided along the longitudinal direction of the first reinforcing pipe, with the first mounting plate being provided with the first mounting through hole that penetrates the first mounting plate in a thickness direction of the first mounting plate, and
the first coupling member is fitted into the first mounting through hole and the first mounted through hole in a state where the first mounting plate is overlapped onto the first mounted plate to thereby allow the first mounting plate to be fixed to the first mounted plate.

7. The lattice boom according to claim 3, wherein
the second main member comprises a second main pipe that extends in a longitudinal direction of the base boom,
the second mounted part comprises a flat plate-like second mounted plate which is provided so as to protrude outward of the base boom from an outer circumferential surface of the second main pipe and which is provided along the longitudinal direction of the second main pipe, with the second mounted plate being provided with the second mounted through hole that penetrates the second mounted plate in a thickness direction of the second mounted plate,
the second mounting part comprises a flat plate-like second mounting plate which is provided so as to protrude from an outer circumferential surface of the second reinforcing pipe and which is provided along the longitudinal direction of the second reinforcing pipe, with the second mounting plate being provided with the second mounting through hole that penetrates the second mounting plate in a thickness direction of the second mounting plate, and
the second coupling member is fitted into the second mounting through hole and the second mounted through hole in a state where the second mounting plate is overlapped onto the second mounted plate to thereby allow the second mounting plate to be fixed to the second mounted plate.

8. The lattice boom according to claim 1, wherein
the first reinforcing lattice member and the second reinforcing lattice member are mounted in a partial region in the longitudinal direction of the base boom,
a distance in the longitudinal direction of the base boom between a proximal end of the first reinforcing lattice member and the foot of the base boom is smaller than a distance in the longitudinal direction of the base boom between a distal end of the first reinforcing lattice member and the tip of the base boom, and
a distance in the longitudinal direction of the base boom between a proximal end of the second reinforcing lattice member and the foot of the base boom is smaller than a distance in the longitudinal direction of the base boom between a distal end of the second reinforcing lattice member and the tip of the base boom.

9. The lattice boom according to claim 8, wherein
the base boom comprises a first foot part which is arranged on the foot of the base boom and provided on the proximal end part of the first main member and which is mounted to the main body of the crane by a foot pin, and a second foot part which is arranged on the foot of the base boom and provided on the proximal end part of the second main member and which is mounted to the main body of the crane by the foot pin,
the first reinforcing lattice member comprises a first proximal end mounting part which is arranged on the proximal end part of the first reinforcing lattice member and provided on the proximal end part of the first reinforcing pipe and which is mounted to the first foot part by the foot pin,
the first mounting part is mounted to a portion positioned further toward the tip side of the base boom than the first foot part among the first main member,
the second reinforcing lattice member comprises a second proximal end mounting part which is arranged on the proximal end part of the second reinforcing lattice member and provided on the proximal end part of the second reinforcing pipe and which is mounted to the second foot part by the foot pin, and
the second mounting part is mounted to a portion positioned further toward the tip side of the base boom than the second foot part among the second main member.

10. The lattice boom according to claim 1, wherein
the two first main members are disposed on the first side surface of the base boom so as to separate from each other in a direction perpendicular to the longitudinal direction of the base boom and the two second main members are disposed on the second side surface of the base boom so as to separate from each other in a direction perpendicular to the longitudinal direction of the base boom,
the first reinforcing pipe comprises first adjacent reinforcing main pipes disposed respectively along the two first main members, and first separated reinforcing main pipes which are disposed so as to separate, with respect to the first adjacent reinforcing main pipes, toward an opposite side to the first side surface and which include portions that extend in the longitudinal direction of the base boom,
the first reinforcing lattice member comprises first reinforcing sub pipes that connect the first adjacent reinforcing main pipes with the first separated reinforcing main pipes,
the second reinforcing pipe comprises second adjacent reinforcing main pipes disposed respectively along the two second main members, and second separated reinforcing main pipes which are disposed so as to separate, with respect to the second adjacent reinforcing main pipes, toward an opposite side to the second side surface and which include portions that extend in the longitudinal direction of the base boom, and
the second reinforcing lattice member comprises second reinforcing sub pipes that connect the second adjacent reinforcing main pipes with the second separated reinforcing main pipes.
